(19) United States
(12) Patent Application Publication
(10) Pub. No.: US 2020/0222927 A1
(43) Pub. Date: Jul. 16, 2020

(54) DEVICE FOR DISPENSING A FLUID, CARTRIDGE FOR A DEVICE, MANUFACTURING METHOD AND PRIMING METHOD

(71) Applicant: GB DEVELOPPEMENT, Vemon (FR)

(72) Inventor: Guillaume BOULAIS, Levallois Perret (FR)

(21) Appl. No.: 16/626,999

(22) PCT Filed: Jun. 28, 2018
(86) PCT No.: PCT/EP2018/067503

§ 371 Date: Dec. 27, 2019

(30) Foreign Application Priority Data
Jun. 28, 2017 (FR) 1755979
Jan. 8, 2018 (FR) 1800014

(51) Int. Cl. B05B 11/00; A45D 34/00

(52) U.S. Cl. CPC B05B 11/3028; B05B 11/3032; B05B 11/3061; B05B 11/00412; A45D 2200/055; B05B 11/007; A45D 34/00; B05B 11/3033; B05B 11/0056

(57) ABSTRACT

A device for dispensing a fluid, including a pocket whose interior volume is delimited by a deformable wall; a pressing surface; a dispensing part including a dispensing cavity; an outlet; a dispensing orifice connecting the pocket to the dispensing cavity; and a dispensing valve located in the dispensing cavity.

### TECHNICAL FIELD

The present invention relates to a device for dispensing a fluid. It also relates to an associated manufacturing method.

Such a device allows a user to dispense a fluid. The field of the invention is more particularly that of the dispensing of products such as liquids, gels or creams, for example for the pharmaceutical or cosmetic or agri-food industry.

### STATE OF THE ART

Fluid dispensers are known, as disclosed, for example, in WO2015155318.

In this field, the manufacturers make permanent efforts to try to improve and/or simplify the compactness, use, ergonomics, manufacture and reloading of such fluid dispensing devices, to improve hygiene.

The object of the present invention is to solve at least one of these problems.

### DISCLOSURE OF THE INVENTION

This object is achieved with a device for dispensing a fluid, comprising:
a pocket (preferably deformable) having an interior volume arranged to contain the fluid, the interior volume being delimited preferably at least in part by a deformable wall,
a pressing surface arranged to, under the effect of pressure, reduce the interior volume of the pocket preferably by deforming the deformable wall if this deformable wall is present,
a dispensing part comprising a dispensing cavity,
an outlet,
a dispensing orifice connecting the pocket to the dispensing cavity,
a dispensing valve located in the dispensing cavity, and in an open state, allows a fluid passage from the inside of the pocket to the outlet via the dispensing orifice and the dispensing cavity, and in a closed state, does not allow a fluid passage from the inside of the pocket to the outlet via the dispensing orifice and the dispensing cavity.

Note that, according to the invention, the deformable wall is optional. In general, it is the pocket that is deformable, whether by a deformable wall or by rigid walls having a relative movement as in a piston. The deformable wall is also optional for all the dependent characteristics below since the deformable wall is not mentioned in this feature.

Dispensing cavity means any physical location in which the dispensing valve is located, whether for example a duct or a hole or interstitial space between two walls or two membranes for example.

The following various technical features may be considered alone or in combination within the scope of the invention.

The dispensing part may be integral with the deformable wall.

The pressing surface may be arranged to, under the effect of pressure, reduce the interior volume of the pocket by deforming the deformable wall while moving the dispensing cavity and the dispensing valve.

There may be continuity of material between the deformable wall and at least a part of the dispensing part.

The pressing surface may be arranged to, under the effect of pressure, reduce the interior volume of the pocket by deforming the deformable wall.

The dispensing part can be arranged to, by exerting pressure on the pressing surface, move at least in a translational movement.

The dispensing part may be arranged to move under exertion of pressure on the pressing surface, having an available degree of freedom in inclination of the dispensing part (preferably at least 2° inclination).

The device according to the invention may comprise guiding means arranged to guide a displacement of the dispensing part, preferably so as to prevent any degree of freedom in inclination of the dispensing part and to limit the displacement of the dispensing part. along a single axis of translation.

The device according to the invention may comprise, inside the pocket, a stop arranged to limit an amplitude of displacement of the dispensing part.

The deformable wall may have, for a maximum value of the interior volume of the pocket, a concave shape on the side of the interior volume of the pocket.

The deformable wall may have a shape memory.

The dispensing part may be located:
outside the pocket, or
inside the pocket.

The dispensing part may be provided with a dispensing ring surrounding the outlet, optionally equipped with a sponge or a fabric or an impregnation means.

The dispensing part may comprise a cap and an insert, the insert being inserted into the cap, the dispensing valve being clamped between the cap and the insert.

The dispensing cavity may comprise a small opening (or a small cavity) of the outlet cavity on the outlet side which has a smaller area (or volume) than a large opening (or a large cavity) of the dispensing cavity on the side of the dispensing orifice.

The dispensing valve may include a portion (preferably stationary between the open and closed states of the dispensing valve) held by clamping between walls of the large opening.

The dispensing valve may include a portion (preferably movable between the open and closed states of the dispensing valve) inserted into the small opening or small cavity.

The device according to the invention may furthermore comprise:
a feed duct,
a feed orifice connecting the feed duct to the inside volume of the pocket,
a feed valve which, in an open state, allows fluid passage from the feed duct to the interior of the pocket via the feed orifice, and, in a closed state, does not allow a fluid passage from the feed duct to the interior of the pocket via the feed orifice.

The feed valve may be located inside the pocket and arranged to:
in its closed state, press against the feed orifice, and
in its open state, move away from the feed orifice.

The device according to the invention may comprise a member provided with:
a dispensing end, housed inside the dispensing part; the dispensing part may optionally comprise a member cavity, the dispensing end being housed inside the member cavity, the dispensing end being arranged to slide inside the member cavity, and/or
a feed end, the feed end carrying the feed valve.

If these two ends are present, these two ends are preferably opposite.

The pressing surface may be arranged to, under the effect of pressure, decrease the interior volume of the pocket by moving the dispensing part so that the member presses the feed valve against the feed orifice in its closed position at least one time.

In the variant where the member cavity is present, the pressing surface can be arranged to, under the effect of pressure, reduce the interior volume of the pocket by moving the dispensing part and the member cavity, so that the dispensing end slides into the member cavity by sinking into the member cavity and so that the member presses the feed valve against the feed orifice in its closed position at least one time.

The device according to the invention may comprise a stop located inside the feed duct.

The stop may be arranged to press against the feed orifice in the absence of pressure on the pressing surface.

In the variant comprising the feed end, it is this feed end that can carry the stop located inside the feed duct.

In the variant comprising the member, the pressing surface may be arranged to, under the effect of pressure, reduce the interior volume of the pocket by moving the dispensing part so that the member moves the stop of the feed orifice.

In the variant comprising the member and the member cavity, the pressing surface may be arranged to, under the effect of pressure, reduce the interior volume of the pocket by moving the dispensing part and the member cavity so that the dispensing end slides into the member cavity by sinking into the member cavity and so that the member moves the stop away from the feed orifice.

The stop may be provided with a through hole, the feed duct may be provided with a through hole, and the stop may be arranged to block any fluid flow through the feed orifice as long as the through hole of the stop does not face the through hole of the feed duct. The through hole of the stop preferably does not face the through hole of the feed duct in the absence of pressure on the pressing surface. The pressing surface may be arranged to, under the effect of pressure, reduce the interior volume of the pocket by moving the dispensing part so that the member pivots on itself and the through hole of the stop is facing the through hole of the feed duct, at least one time.

The device according to the invention may comprise a refill connector arranged to allow a refill of fluid inside the device according to the invention without this fluid passing through the pocket and/or the dispensing valve (and/or the feed valve if present).

The refill connector can be arranged to:
when connected to the refill connector, push a rod to a point upstream of the dispensing valve so as to block a flow of fluid upstream of the dispensing valve, preferably so as to block the dispensing valve. feed orifice and/or dispensing orifice
when disconnecting from the refill connector, pull the rod so that the rod no longer blocks a flow of fluid upstream of the dispensing valve, preferably so as to open the feed orifice and/or the dispensing orifice.

The rod can pass through the feed duct or a fluid reservoir.

The refill connector may, in a variant comprising the stop and/or the feed orifice, be arranged to:
when connected to the refill connector, push a rod against the stop and/or the feed orifice so as to:
   hold the stop against the feed orifice and/or
   plug (by the rod and/or stop) the feed orifice, and/or
when disconnecting from the refill connector, pull the rod so that:
   the rod no longer touches the stop and no longer blocks the displacement of the stop, and/or
   the rod no longer closes the feed orifice.

The refill connector may be arranged to:
when connected to the refill connector, push a rod against the dispensing orifice and plug (through the rod) the dispensing orifice, and/or
when disconnecting from the refill connector, pull the rod so that the rod no longer closes the dispensing orifice.

According to one aspect of the invention:
the interior volume of the pocket may be delimited at least in part by the deformable wall and by a bottom wall.

The dispensing valve can be held between the dispensing part and the bottom wall or in the dispensing part.

The cavity and the dispensing part can be driven into the bottom wall.

The cavity may have an oblique inclination direction forming an angle of at least 3° with respect to at least one laying plane of the deformable wall on the part forming the bottom wall.

According to one aspect of the invention:
the bottom wall may be integral with an end piece,
the device according to the invention may comprise a reservoir delimited by walls fixed to the end piece
the device according to the invention may comprise a feed orifice connecting the reservoir to the interior volume of the pocket,

so that:
the pocket can be located inside the reservoir.

Depending on the variant considered:
the end piece and the dispensing part can be in one and the same piece, preferably without discontinuity of material, or
the dispensing part (preferably the dispensing cavity) can carry the dispensing orifice and be assembled with (preferably at least partly (preferably only partially) inserted into) the end piece on the side of its dispensing orifice.

The device according to the invention may comprise a feed valve which, in an open state, allows fluid passage from the feed duct to the interior of the pocket via the feed orifice, and in a closed state, does not allow a fluid passage from the feed duct to the interior of the pocket via the feed orifice.

The feed valve may be integral with the dispensing valve; the feed valve and the dispensing valve may be in a single piece of a single material.

The feed valve may be located inside the pocket.

The dispensing valve may be located outside the pocket.

The dispensing valve may be located in the device according to the invention according to an assembly by insertion through the dispensing orifice, the dispensing valve being able to be kept blocked without any possible outlet from the cavity on the side of the dispensing orifice by means of a blockage by the end piece.

The dispensing part may comprise a wall located outside the end piece and which:
is visible from outside the device, and/or
runs along the dispensing valve from the outlet, and/or
is of substantially constant thickness.

According to one aspect of the invention, the deformable wall may comprise no moving part inside the dispensing part.

The dispensing part may comprise a cap and an insert, the insert being inserted into the cap:
the dispensing valve is preferably maintained in the cavity by clamping between the cap and the insert.

Preferably, there is no space between an inner wall of the cap and an outer wall of the insert.

The insert may comprise a rib or protrusion arranged to drive the dispensing valve into its cavity during insertion of the insert into the cap.

The deformable wall may be secured to the dispensing part by overmolding one on the other.

According to one aspect of the invention:
the device according to the invention may comprise a plurality of outlets and a plurality of dispensing orifices,
the dispensing part may comprise a plurality of dispensing assemblies, each dispensing assembly comprising a dispensing cavity in which is located a dispensing valve which, in an open state, allows a fluid passage from the interior of the pocket to an associated outlets via one of the dispensing orifices associated with it and its dispensing cavity, and, in a closed state, does not allow a fluid passage from the interior of the pocket to its associated outlet via the dispensing orifice associated with it and its dispensing cavity.

The deformable wall may have a concave shape oriented towards the orifice(s) of dispensing and/or closed by a wall provided with a substantially flat edge carrying one or more dispensing parts.

The outlet(s) may open onto a sponge and/or a fabric and/or a means for impregnating the product to be dispensed and/or a sieve and/or a ball holder.

The interior volume of the pocket may comprise a sponge or a cloth or a means for impregnating the product to be dispensed.

The device according to the invention may comprise:
a reservoir
a feed orifice connecting the reservoir to the interior volume of the pocket, the interior volume of the reservoir comprising a sponge or a means for impregnating the product to be dispensed.

The device according to the invention may comprise adjusting means arranged to reduce the volume of the reservoir without touching the pressing surface.

According to one aspect of the invention:
the interior volume of the pocket may be delimited at least in part by the deformable wall and by a bottom wall
the device may comprise a reservoir delimited by reservoir walls and the bottom wall.

The bottom wall can be arranged so that only two exits allow access to the interior of the reservoir: a feed orifice and a filling hole.

Preferably, at least one of the reservoir walls and the bottom wall can be assembled to the deformable wall in a single piece.

The dispensing valve may be located between one end of the pocket and a through hole passing through the dispensing part and connecting the pocket to the cavity.

The dispensing part may form a spout in which the cavity is located, the dispensing part and the reservoir are then preferably mounted inside a case formed by two parts, one of these parts comprises a head, the spout is mounted by insertion in this head from the interior of the case.

The dispensing valve preferably has at least one of its points located less than 6 mm from the outlet.

The dispensing part and the deformable wall may form a single piece without discontinuity of material.

The cavity may comprise a small opening and a large opening, the passage between the large opening and the small opening being made by a filling element of the cavity.

The device according to the invention may comprise a rigid element connecting the bottom wall and the dispensing part and arranged to guide a translation of the dispensing part relative to the bottom wall, the dispensing valve being arranged to slide by friction around the rigid element so that, in the open position of the dispensing valve, the dispensing valve releases a passage of the fluid to be dispensed along a lateral channel located in the dispensing part and connecting the pocket to the outlet.

The dispensing part may be located at the top of the pocket which has a shape of truncated cone.

The dispensing part may have a spout shape and the cavity may be located in a removable part relative to the dispensing part.

All the above technical features can be claimed independently of each other. In particular, the characteristics concerning:
the solidarity and/or the respective arrangement between the dispensing part and the deformable wall,
the small opening and the large opening of the dispensing cavity,
the refill connector,

are independent of each other.

According to another aspect of the invention, there is provided a method of manufacturing a device according to the invention, characterized in that the reservoir is filled with the fluid to be dispensed by filling means, before assembling the deformable wall and the bottom wall, so that, during filling:
the fluid for filling the reservoir enters via the filling hole but can not leave the reservoir via the filling hole
the gas initially inside the reservoir can not leave the reservoir via the filling hole
the fluid filling the reservoir and the gas initially inside the reservoir can escape from the reservoir only via the feed orifice.

The filling may be performed until the fluid to be dispensed goes beyond the feed orifice or reaches the feeding seat or at least until the fluid to be dispensed goes beyond the feed orifice or reaches the feeding seat see even partially fill the pocket.

After the step of filling:
the bottom wall and the deformable wall may be assembled so as to form the pocket and
the filling hole may be plugged.

According to another aspect of the invention, there is provided a method of manufacturing a device according to the invention, characterized in that it comprises a step of filling at least a portion of the pocket while it is open in communication with the outside of the device according to the invention without passing through the dispensing valve, preferably, if this device according to the invention comprises a reservoir, either in the same step of filling the reservoir, or before or after a step of filling the reservoir.

According to another aspect of the invention, there is provided a method for priming a device according to the invention, characterized in that the fluid to be dispensed contained in the reservoir is subjected to an overpressure without the dispensing valve blocking the flow of gas or fluid to be dispensed.

According to the variants:
the fluid to be dispensed contained in the reservoir (13) may be subjected to an overpressure by pressing on the reservoir to compress the contents, and/or
the dispensing valve may be opened for example by pressing the dispensing valve by means of a tool.

Priming may be performed until the fluid to be dispensed goes beyond the feed orifice or reaches the feeding seat.

According to yet another aspect of the invention, there is provided a method of manufacturing a device according to the invention, preferably with a cavity comprising the small opening and the large opening as previously described, characterized in that the dispensing valve is mounted in the dispensing cavity by insertion through the dispensing orifice.

According to yet another aspect of the invention, there is provided a cartridge for a device according to the invention comprising:
a bottom wall
a feed valve
a pocket provided with a connector (intended to be connected to a dispensing valve), comprising at least one portion that can be pierced or opened, and preferably comprising a deformable wall
preferably a reservoir (preferably flexible), preferably formed by a film and/or a skirt formed by the bottom wall and/or the deformable wall. This reservoir is preferably filled completely or partially (at least 10% of its interior volume) with product (fluid) to be dispensed. The reservoir may also be ultrasonically welded to the bottom wall and/or the deformable wall.

### DESCRIPTION OF THE FIGURES AND EMBODIMENTS

Other advantages and particularities of the invention will appear on reading the detailed description of implementations and non-limiting embodiments, and the following appended drawings:

FIGS. 1 to 3 are views of a device 101 of a first embodiment according to the invention, which is the preferred embodiment of the invention, of which

FIG. 1 is a profile sectional view,

FIG. 2 is a perspective view,

FIG. 3 is a sectional view of the part 23 (without the part 28) and of the valve 5 according to the sectional plane I of FIG. 1,

FIG. 4 is a partial cross-sectional view of a variant of the device 101,

FIG. 5 is a profile sectional view of a part of another variant of the device 101,

FIG. 6 is a profile sectional view of a part of another variant of the device 101,

FIGS. 7, 8 and 9 are views of another variant of the device 101, of which:

FIG. 7 which is a profile sectional view,

FIG. 8 which is a perspective view,

FIG. 9 is a partial sectional view of profile

FIGS. 10 and 11 are views of another variant of the device 101, of which:

FIG. 10 which is a profile sectional view,

FIG. 11 which is a perspective view,

FIGS. 12, 13 and 14 are views of a device 102 of a second embodiment according to the invention, of which:

FIG. 12 which is a profile sectional view,

FIG. 13 which is a partial profile sectional view,

FIG. 14 is a perspective view of the member 31 forming part of the device 102,

FIGS. 15, 16 and 17 are views of a variant of the device 102 of the second embodiment according to the invention, of which:

FIG. 15 which is a partial sectional section view,

FIG. 16 which is a partial profile sectional view,

FIG. 17 is a perspective view of the member 31,

FIGS. 18 to 21 are views of a device 103 of a third embodiment 103 according to the invention, of which:

FIG. 18 which is a profile sectional view,

FIG. 19 which is a partial profile sectional view,

FIG. 20 which is a profile sectional view while the device 103 is connected to be refilled with fluid,

FIG. 21 is a perspective view of the member 31 forming part of the device 103,

FIG. 22 is a sectional view of a portion of a variant of the second and third embodiment of device 102, 103 according to the invention;

FIGS. 23 and 24 are views of a device 104 of a fourth embodiment according to the invention, of which:

FIG. 23 which is a profile sectional view,

FIG. 24 which is a partial perspective view without the reservoir,

FIGS. 25, 26, 27 and 28 are views of a variant of the device 104 of the fourth embodiment according to the invention, of which:

FIG. 25 which is a perspective sectional view,

FIG. 26 which is a perspective view of the valve 5 of this variant,

FIG. 27 is a perspective sectional view of the cavity 8 of the valve 5 of this variant,

FIG. 28 is a sectional view of the cavity 8 and of the valve 5 of this variant,

FIGS. 29, 30, 31 and 32 are views of a variant of the device 101 of the first embodiment according to the invention, of which:

FIG. 29 which is a profile sectional view,

FIG. 30 which is a view of different disassembled elements of this variant,

FIG. 31 is a close-up of FIG. 29,

FIG. 32 is a perspective view of the reservoir in its open state before assembly with the rest of the device 101,

FIGS. 33, 34 and 35 are views of a variant of the device 103 of the third embodiment according to the invention, of which:

FIG. 33 which is a profile sectional view,

FIG. 34 which is a profile section view of part of this variant before assembling with the other parts of this variant,

FIG. 35 is a perspective view,

FIG. 36 is a partial sectional view of a variant of the device 103 of the third embodiment according to the invention,

FIGS. 37, 38 and 39 are views of a variant of the device 101 of the first embodiment according to the invention, of which:

FIG. 37 which is a partial perspective view,

FIG. 38 which is a profile sectional view,

FIG. 39 is a sectional view.

FIG. 40 is a view of a variant of the device according to the invention,

FIGS. 41 and 42 are profile sectional views of a variant of the device 101,

FIG. 43 is a sectional side view of a variant of the device 101,

FIG. 44 is a profile sectional view of a variant of the device 104 and FIG. 45 is a perspective view of the valve 4 for this variant of the device 104,

FIG. 46 is a sectional view and FIG. 47 is a partial perspective view of another variant of the device,

FIG. 48 is a perspective view of part of a device 335 of a fifth embodiment according to the invention,

FIG. 49 is a partial sectional view of the device 335,

FIG. 50 is a perspective view of the dispensing valve 5 and feed valve 4 of the device 335;

FIG. 51 is a partial perspective view of the device 335 during assembly,

FIG. 52 is a sectional view of the device 335 assembled,

FIG. 53 is a profile sectional view of the cavity 8 that can replace the cavity 8 of each of FIGS. 1 to 40 and 44 to 47 and 57 to 58,

FIG. 54 is a partial sectional view of a device 106 of a sixth embodiment according to the invention,

FIG. 55 is a partial profile sectional view of the device 106 of the sixth embodiment according to the invention,

FIG. 56 is a partial perspective view of the device 106 of the sixth embodiment according to the invention,

FIGS. 57 and 58 are partial sectional views of a variant of the device 106 of the sixth embodiment according to the invention,

FIGS. 59 to 64 illustrate a seventh embodiment 700.

As these embodiments are in no way limitative, it is possible in particular to consider variants of the invention comprising only a selection of characteristics described or illustrated below in isolation from the other characteristics described or illustrated (even if this selection is isolated within a sentence comprising these other characteristics), if this selection of characteristics is sufficient to confer a technical advantage or to differentiate the invention with respect to the state of the art; This selection comprises at least one preferably functional characteristic without structural details, and/or with only a part of the structural details if this part alone is sufficient to confer a technical advantage or to differentiate the invention with respect to the state of the art.

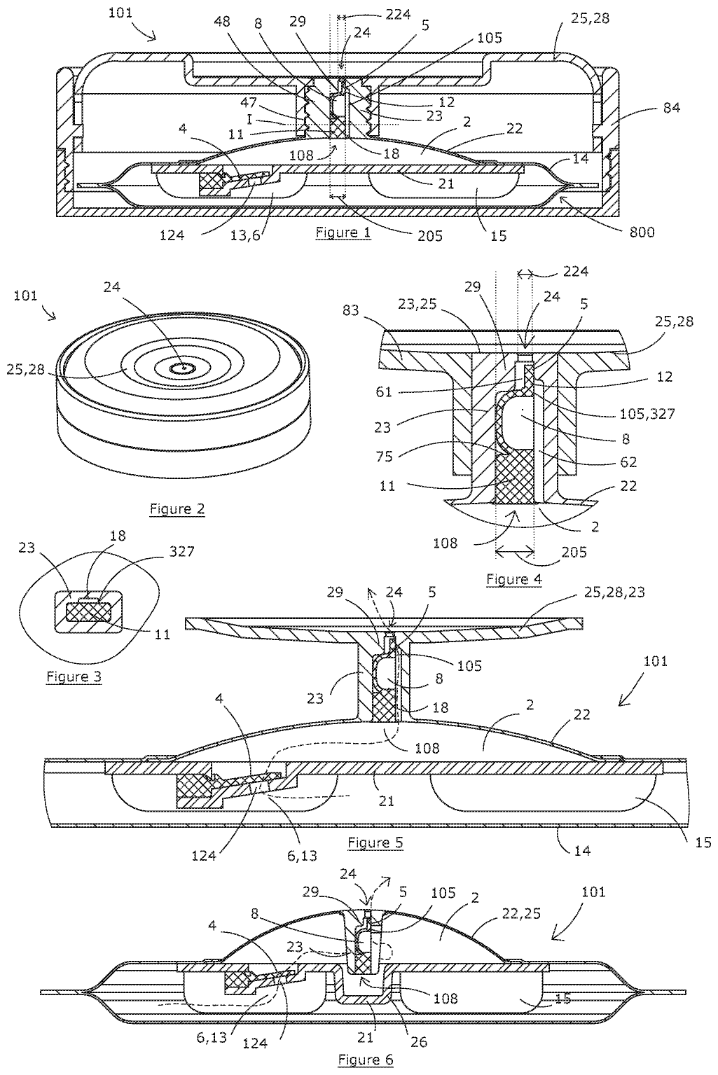

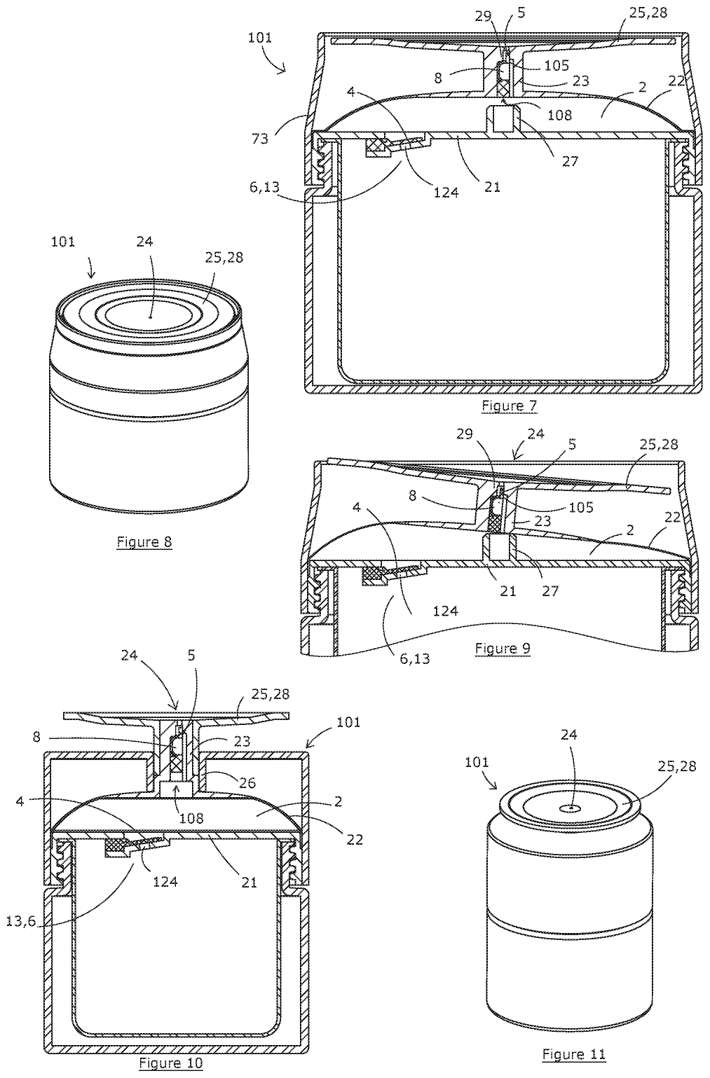

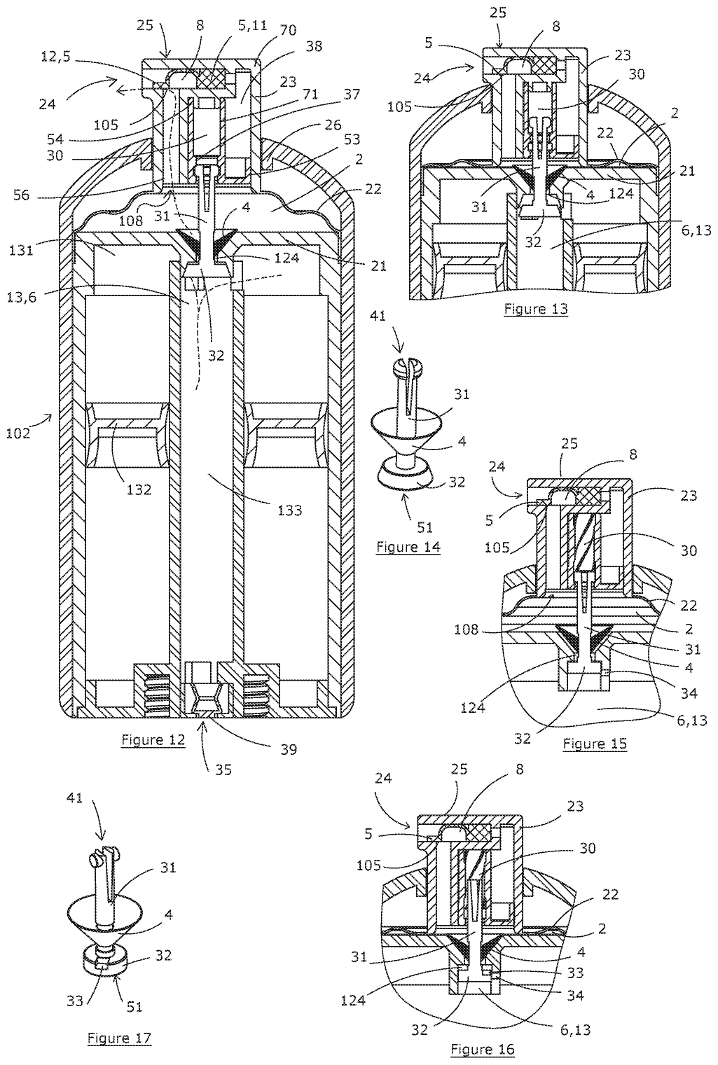

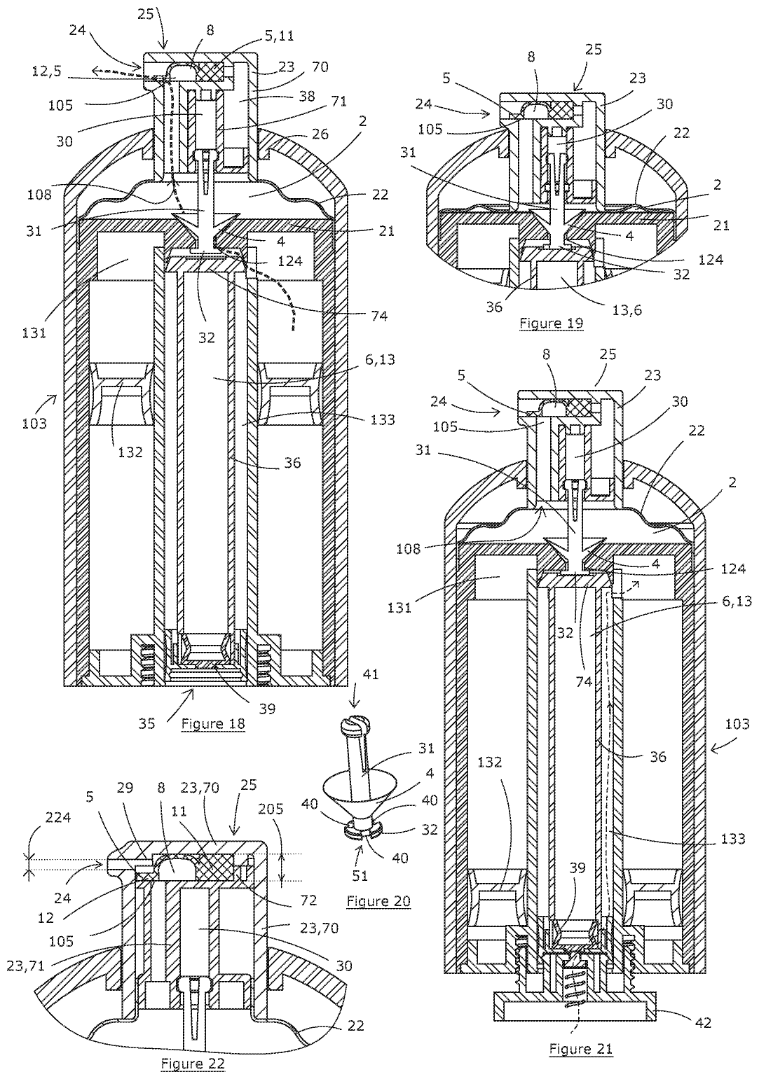

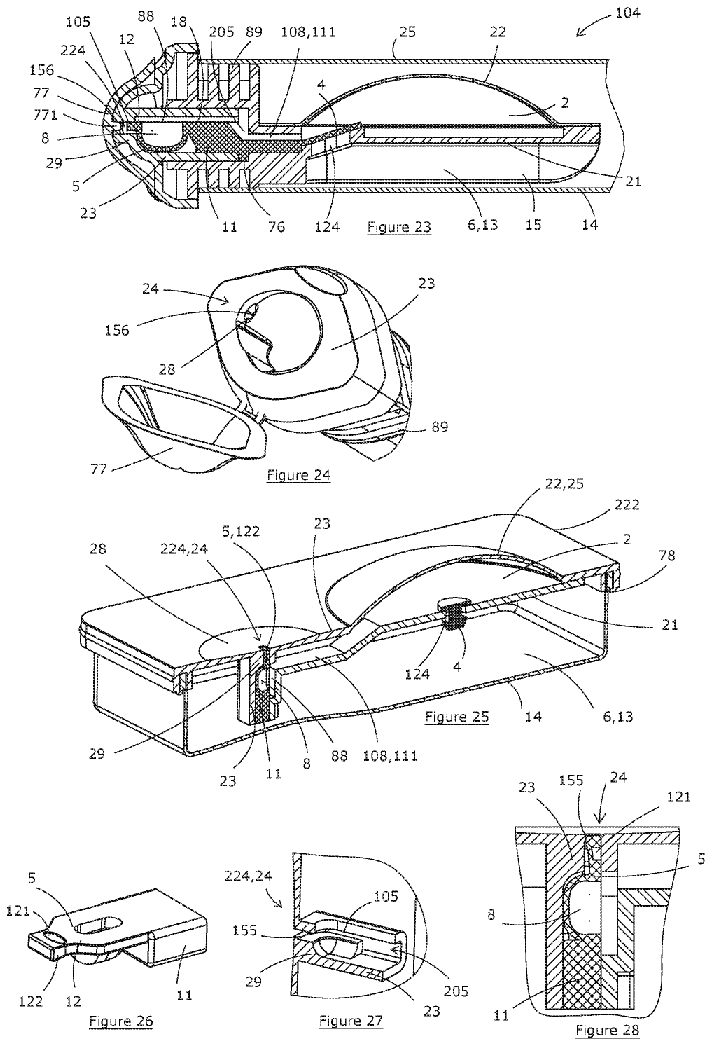

Firstly, with reference to FIGS. 1 to 3, a first embodiment of device 101 according to the invention for dispensing a fluid will be described.

Unless otherwise stated and in a purely illustrative way:
each valve of the device 101 (preferably flexible) is typically made of thermoplastic elastomer (TPE) or a thermoplastic polyurethane elastomer of 80 Shore A,
all the other parts of the device 101 (typically rigid or semi-rigid) are of polypropylene (abbreviated as PP in the rest of the present description).

The fluid comprises a liquid and/or a gas, and is preferably a liquid, a cream, a paste, a gel or a mixture thereof.

The device 101 for dispensing a fluid comprises a pocket 2 having an interior volume arranged to contain the fluid, the interior volume being delimited at least in part by a deformable wall 22.

The pocket 2 is formed by a bottom wall 21 and by the flexible deformable wall 22.

The walls 21 and 22 face each other.

The wall 22 has a concave shape oriented towards the bottom wall 21.

In the present description, any notion of displacement or mobility must be understood as a displacement or a mobility relative to the bottom wall 21.

The wall 22 forms a skirt and has an upper portion and a lower portion.

The deformable wall 22 (more precisely its lower part) is fixed or welded to the bottom wall 21.

The bottom wall 21 preferably has a planar or substantially planar shape.

The bottom wall 21 is a rigid wall, that is to say more rigid than the wall 22.

The deformable wall 22 is for example a thin wall and the bottom wall 21 is for example a wall thicker than the wall 21.

The walls 21 and 22 are for example polypropylene.

The wall 22 is preferably made of PP with a polymer or plastomer additive (such as, for example, Vistamaxx™ 6202), in order to reduce the hardness thereof so that the hardness of the wall 22 is less than 80 Shore D. Therefore it avoids excessive finesse and fragility of the wall 22.

The device 101 comprises a dispensing part 23 comprising a dispensing cavity 8. The device 101 comprises a pressing surface 25 arranged to, under the effect of pressure and through the dispensing part 23, reduce the interior volume of the pocket 2 by deforming the deformable wall 22.

The pressing surface 25 is integral with the dispensing part 23, and preferably comprises at least a part of the dispensing part 23.

The device 101 includes an outlet 24.

The outlet 24 opens on the outside of the device 101.

The outlet 24 is located on the dispensing part 23.

The pressing surface 25 surrounds the outlet 24.

The outlet 24 is arranged to distribute fluid in a direction substantially perpendicular to the pressing surface 25.

The outlet 24 is arranged to distribute fluid in a direction substantially parallel to an axis of elongation of the cavity 8.

The device 101 comprises a dispensing orifice 108 connecting the pocket 2 to the dispensing cavity 8.

The device 101 comprises a dispensing valve 5 located in the dispensing cavity 8, and in an open state, allows fluid passage from the inside of the pocket 2 to the outlet 24 through the dispensing orifice 108 and the dispensing cavity 8, and, in a closed state, does not allow a fluid passage from the inside of the pocket 2 to the outlet 24 through the dispensing orifice 108 and the dispensing cavity 8.

The dispensing part 23 is integral with the deformable wall 22.

The dispensing part 23 is located on a top of the concave shape of the deformable wall 22, that is to say on the upper part of the wall 22.

The junction line between the dispensing part 23 and the deformable wall 22 is a closed curve surrounding the dispensing part 23.

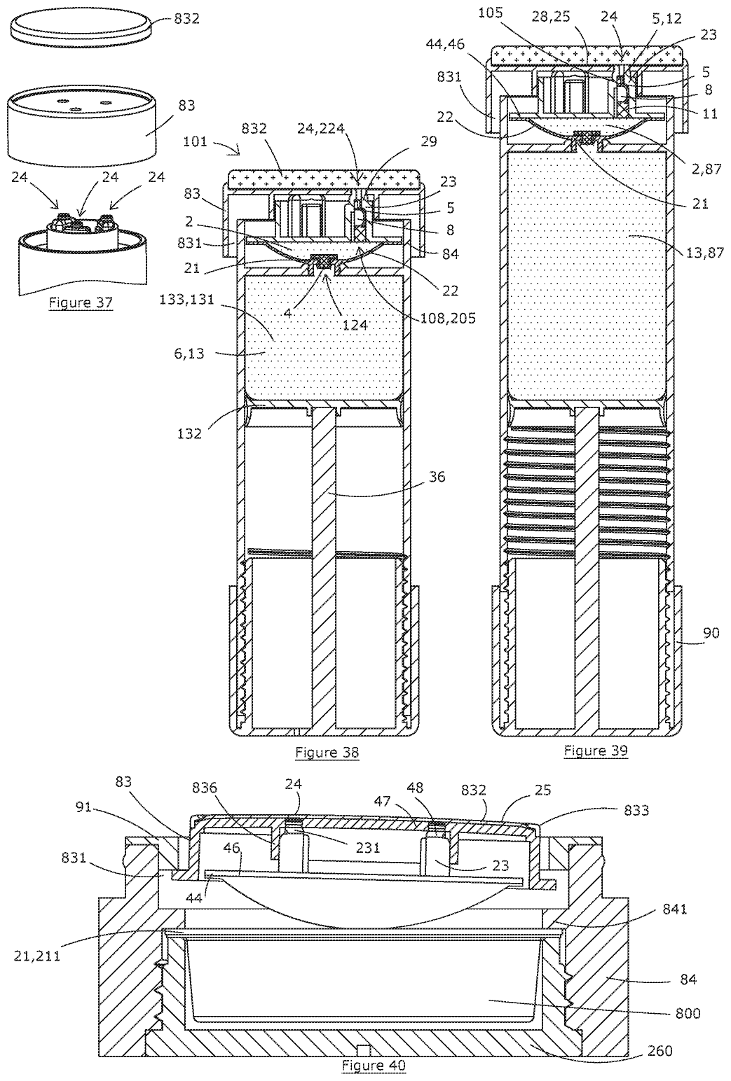

At the junction between the part 23 and the wall 22, it is noted that the wall 22 is thicker than elsewhere, especially at its periphery. In other words, the wall 22 is thicker on its upper part than on its lower part. This makes it possible to widen the deformation: a small pressure on the edge causes a greater deformation of the wall 22. The stresses are less extensive and this improves the lifetime of the device. This thicker part may carry a plurality of dispensing parts 23 in a case with a plurality of outlets 24 (as will be seen later in the case of FIGS. 37 to 40).

The pressing surface 25 is arranged to, under the effect of pressure, reduce the interior volume of the pocket 2 by deforming (and moving) the deformable wall 22 while moving the dispensing cavity 8 and the dispensing valve 5 towards the bottom wall 21. The direction of the liquid is opposite to the pressing direction on the device, and is even central.

By making the dispensing part 23 and the deformable wall 22 integral, the compactness of the device and its simplicity of use and manufacture are thus considerably improved.

The cavity 8 extends along an axis that passes through the pocket 2, the deformable wall 22 and the bottom wall 21.

There is a continuity of material between the deformable wall 22 and the dispensing part 23. The wall 22 and the part 23 are grouped together in a single piece of the same material without discontinuity of material, for example in PP having a lower hardness at 80 Shore D and/or a flexural modulus less than 1000 MPa.

The pressing surface 25 is arranged to, under the effect of pressure, reduce the interior volume of the pocket 2 by deforming the deformable wall 22, more exactly by crushing it in the direction of the bottom wall 21. The direction of the dispensing liquid is opposed to the pressing direction on the pressing surface 25 and the outlet is central on the deformable wall.

The dispensing part 23 is arranged to, by exerting pressure on the pressing surface 25, to move at least in a translational movement.

The deformable wall 22 has, for a state of a maximum value of the interior volume of the pocket 2, a concave shape on the side of the interior volume of the pocket 2; for example a dome shape (substantially round or square or oval or other).

The deformable wall 22 has a shape memory. When this wall 22 does not undergo any external stress, it resumes or remains in its (preferably concave) shape which maximizes the volume of the pocket 2.

The dispensing part 23 is located outside the pocket 2.

The dispensing part 23 is provided with a dispensing ring 28 surrounding the outlet 24.

The dispensing ring 28 is screwed onto the dispensing part 23.

The ring 28 is for example made of PP. The product exits at the dispensing ring 28, the distance between the closure of the valve (more precisely the dispensing seat 105) and this dispensing ring is of a distance of less than 6 mm.

The pressing surface 25 is located partly on the dispensing part 23 (around the outlet 24) and on an outer surface of the ring 28.

This pressing surface 25, accessible from outside the device 101 by a hand of a user, has a minimum surface area of 20 mm².

The dispensing cavity 8 comprises a small opening 224 (or a small cavity 61) of the dispensing cavity 8 on the side of the outlet 24 and a large opening 205 (or a large cavity 62) of the dispensing cavity 8 on the side of the dispensing orifice 108, and the former has a smaller area (or volume) than the latter.

The dispensing cavity may comprise two spaces (or volumes), a large cavity 62 and a small cavity 61 connected to the outlet 24.

The small opening 224 (or respectively small cavity 61) of the dispensing cavity 8 on the side of the outlet 24 has an area at least two times smaller than the large opening 205 of the dispensing cavity 8 on the side of the dispensing orifice 108.

The passage between the large opening 205 (or large cavity 62) and the small opening 224 (or the small cavity 61) is made typically by a step or filling member 29 of the cavity 8. Note that this step 29 in the dispensing channel is connected to the outlet 24 and is downstream of the dispensing valve 5 (unlike the rod valve, the section reduction is before the closing of the valve).

The filling member 29 is typically the seal of the valve 5 with a gap of 0 to 0.5 mm, possibly less the cylindrical passage that connects the outlet to the cavity (cylinder) outlet.

The filling element 29 also forms a stop 75 for the insertion of the valve 5 into the cavity 8 in the direction of the outlet 24.

Such a passage makes it possible in particular to limit the dead volumes of fluid at the cavity and the outlet 24, and to improve the hygiene.

The dispensing valve 5 comprises a portion 11 held by clamping between the inner walls of the cavity 8 at the large opening 205.

The portion 11 is stationary between the open and closed states of the dispensing valve.

A duct 18 allows the fluid passage between the portion 11 and the inner walls of the cavity 8 at the large opening 205 (or respectively large cavity 62).

The dispensing valve 5 comprises a movable portion 12 which, in the closed state of this dispensing valve 5, is pressed against a dispensing seat 105 so as to plug the dispensing seat 105, and in the open state of this dispensing valve 5, deviates from the dispensing seat 105 so as to open the dispensing seat 105.

The duct 18 is provided with a stop 327 at the dispensing seat 105, this stop 327 being arranged to compress the dispensing valve, more exactly the movable part or membrane 12 of the valve 5.

The duct 18 runs along the cavity 8 in the same direction of elongation. The duct 18 and the cavity 8 have the same direction of elongation.

The duct 18 forms a groove dug in the dispensing part 23 from the cavity 8.

This part 12 is a membrane or lamella.

The dispensing valve 5 comprises a portion 12 inserted in the small opening 224 (or in the small cavity 61). This portion 12 is the movable membrane 12 of the valve 5. The portion 12 is located in the small cavity 61 and the portion 11 is located in the large cavity

The part 12 is movable between the open and closed states of the dispensing valve.

The passage between the large opening 205 (or large cavity 62) and the small opening 224 (or the small cavity 61) further simplifies the mounting of the valve 5 in the cavity 8, by mounting “from the rear” that is to say by pushing on the solid portion 11 rather than “from the front” by pushing on the membrane or lamella 12 which is mobile and fragile.

Note further that the dispensing seat 105 is a lateral portion of the inner walls of the cavity 8, that is to say that seat 105 is limited to one face, preferably flat (or curved), the inner walls of the cavity 8, and does not all around a section of the cavity 8 which would be made in a plane perpendicular to the direction of elongation of the portion of the cavity 8 containing the valve 5. The cavity 8 has a passage groove 88, the dispensing seat partially surrounds this groove 88, the portion 11 closes the groove 88 to form a sealed passage.

The device 101 comprises a feed duct 6 coincident (as illustrated in the figures) or connected with a reservoir 13 of fluid.

The duct 6 and/or reservoir 13 is delimited at least in part by a flexible wall 14 or a flexible bag 14, typically made of multilayer polyethylene terephthalate (PET)/aluminum/cast polypropylene (PP) film, the PET layer being towards the outside of the bag 14.

The device 101 comprises a feed orifice 124 connecting the feed duct 6 to the inside volume of the pocket 2.

The device 101 comprises a feed valve 4 which, in an open state, allows a fluid passage of the feed duct 6 towards the interior of the pocket 2 via the feed orifice 124, and in a closed state, does not allow a fluid passage of the feed duct 6 to the inside of the pocket 2 via the feed orifice 124.

The feed valve 4 is located inside the pocket 2 and is arranged for:
in its closed state, press against the feed orifice 124, and
in its open state, move away from the feed orifice 124.

The feed valve 4 (movable between its closed and open positions) is, in its closed state, kept pressed against a stationary part (called feeding seat, which surrounds at least partially the periphery of the feed orifice 124 associated) which is also a “rigid” part (ie not flexible material) of an inner wall of the pocket 2. More specifically, the feed valve 4 comprises a membrane which, in the closed state of the feed valve 4, is held pressed against the feeding seat, and moves away from this feeding seat in its open state.

The feeding seat is located inside the pocket 2, on the wall 21.

At rest, that is to say without the device 101 undergoes stress or external force, the valve 5 is in its closed state.

Preferably, even if this is less essential, at rest, that is to say without the device 101 does not undergo stress or external force, the valve 4 is also in its closed state.

When the pocket 2 is filled with fluid to be dispensed and the volume of the pocket 2 decreases (for example due to an increase in pressure on the pressing surface 25):
the dispensing valve 5 (more exactly the membrane 12) deviates from the dispensing seat 105 and the valve 5 is in its open state; fluid exits the outlet 24 and the pocket 2 is at least partially empty,
the feed valve 4 is pressed against the feed orifice 124 and the valve 4 is in its closed state; fluid can not (or almost not) escape from the pocket 2 to the duct 6.

When the pocket 2 is filled with fluid to be dispensed and the volume of the pocket 2 increases (for example by releasing a pressure on the pressing surface 25):
the dispensing valve 5 (more exactly the membrane 12) flattens on the dispensing seat 105 and the valve 5 is in its closed state; fluid can not pass from pocket 2 to outlet 24,
the feed valve 4 is “sucked” and away from the feed orifice 124 and the valve 4 is in its open state; fluid can pass from the duct 6 to the pocket 2 so as to refill the pocket 2.

Optionally, the outer surface of the ring 28 may carry a sponge (not shown) or a fabric or impregnating means arranged to imbibe with the fluid exiting through the outlet 24. In this case, the outlet 24 does not open directly on the outside of the device 101 but on the sponge or fabric or impregnation means. This sponge or fabric or impregnation means hides the outlet 24. The pressing surface 25, accessible from outside the device 101 by a hand of a user, is then located at least partly on an outer surface of the sponge or fabric or impregnation means, and possibly partly on an outer surface of the ring 28. In another version, the fabric or impregnating means can be replaced or associated with a sieve to filter residues.

The inside of the duct 6 and/or reservoir 13 comprises at least one rib 15 arranged to limit a crushing of the duct 6 and/or reservoir 13 respectively and to limit an amplitude of reduction of the volume of the duct 6 and/or the reservoir 13, respectively.

In one embodiment of manufacturing method of the device 101, the dispensing valve 5 is mounted in the dispensing cavity 8 by insertion through the dispensing orifice 108, that is to say from the inside of the pocket 22 before welding or assembling the parts 21 and 22 of the pocket 2.

A dispensing channel connects the outlet 24 to the inside of the pocket 2.

This dispensing channel comprises the cavity 8.

A variant of the device 101 will now be described with reference to FIG. 4 only for its differences with respect to FIGS. 1 to 3.

In this variant, the dispensing ring 28 is engaged or clipped on the dispensing part 23.

The dispensing part 23 and the movable dispensing wall 83 have connection means 48, 47. This connection is a nesting, screwing or other, preferably a sealed connection.

This device 101 may comprise a refill 800, comprising the pocket 2, the reservoir 13, the dispensing part 23, the bottom wall 21. This refill is inserted through the top of a case 84, the movable dispensing wall 83 just connect to the refill through connection means 47, 48.

Another variant of the device 101 will now be described with reference to FIG. 5 only for its differences with respect to FIGS. 1 to 3.

In this variant, there is a continuity of material between the dispensing ring 28 and the dispensing part 23. The ring 28 and the part 23 are grouped together in a single piece of the same material without discontinuity of material, for example in PP.

Another variant of the device 101 will now be described with reference to FIG. 6 only for its differences with respect to FIGS. 1 to 3.

In this variant, the device 101 comprises guiding means 26 arranged to guide a displacement of the dispensing part 23, so as to prevent any degree of freedom in inclination of the dispensing part 23 and to limit the displacement of the dispensing part 23 according to a single translation axis aligned in the direction of the bottom wall 21, that is to say passing through the wall 21.

The dispensing part 23 is located inside the pocket 2.

In this variant, the device 101 does not comprise a ring 28.

The pressing surface 25 is located partly on the dispensing part 23 (around the outlet 24) and on the outer surface (opposite inside the pocket 2) of the wall 22.

The bottom wall 21 comprises a recess arranged to receive at least a portion of the dispensing part 23 after the dispensing part has moved towards the bottom wall 21.

This recess is also the guide means 26.

The pressing surface 25 does not use the dispensing part 23 to reduce the interior volume of the pocket 2 by deforming the deformable wall 22.

A further variant of the device 101 will now be described, with reference to FIGS. 7, 8 and 9, solely for its differences with respect to the variant of FIG. 5.

In this variant of FIGS. 7, 8 and 9, the dispensing part 23 is arranged to, when a pressure is exerted on the pressing surface 25, move while leaving available a degree of freedom in inclination of the dispensing part 23 as illustrated in FIG. 9, according to at least 2° inclination angle.

In this variant of FIGS. 7, 8 and 9, the device 101 comprises, inside the pocket 2, a stop 27 arranged to limit an amplitude of displacement of the dispensing part 23 towards the bottom wall 21.

The device 101 comprises a skirt 73 that hides the deformable wall 22 to a user looking at the device 101 from outside the device 101.

A further variant of the device 101 will now be described, with reference to FIGS. 10 and 11, solely for its differences with respect to the variant of FIG. 5.

In this variant of FIGS. 10 and 11, the device 101 comprises guiding means 26 arranged to guide a displacement of the dispensing part 23.

The guiding means 26 are arranged to prevent any degree of freedom in inclination of the dispensing part 23 and to limit the displacement of the dispensing part 23 along a single translation axis aligned in the direction of the bottom wall 21.

The guiding means 26 conceal the deformable wall 22 to a user looking at the device 101 from outside the device 101.

A second embodiment of the device 102 according to the invention will now be described with reference to FIGS. 12, 13 and 14 only for its differences with respect to the embodiment of FIGS. 1 to 3.

The device 102 comprises guiding means 26 arranged to guide a displacement of the dispensing part 23.

The means 26 are arranged to prevent any degree of freedom in inclination of the dispensing part 23 and to limit the displacement of the dispensing part 23 along a single translation axis aligned in the direction of the bottom wall 21.

The outlet 24 is arranged to distribute fluid in a direction substantially perpendicular to the single axis of translation of the part 23 and/or substantially parallel to the pressing surface 25. This is called lateral dispensing.

The dispensing part 23 (also called dispensing head 23) comprises:
a cap 70, and
an insert 71.

The insert 71 is inserted into the cap 70.

There is continuity of material between the deformable wall 22 and at least a part (more exactly the cap 70) of the dispensing part 23. The wall 22 and at least a part (more exactly the cap 70) of the part 23 are grouped into a single piece of the same material without discontinuity of material, for example PP.

The cavity 8 is located inside the at least one portion 70 (of the dispensing part 23) having a continuity of material with the wall 22.

The valve 5 is located inside the at least one portion 70 (of the dispensing part 23) having a continuity of material with the wall 22.

The connection between the cap 70 and the insert 71 is sealed so as to have a pocket 38 of air or gas sealed. This seal is obtained for example by a skirt 53 and a connection 54.

All the contact areas 53, 54 between the cap 70 and the insert 71 are sealed by clamping or ultrasonic welding.

The device 102 comprises a member 31 provided with two opposite ends, namely:
a dispensing end 41, and
a feed end 51.

The dispensing end 41 is housed inside the dispensing part 23.

The dispensing part 23 (more exactly the insert 71) comprises a member cavity 30.

The dispensing end 41 is housed inside the member cavity 30.

The dispensing end 41 is arranged to slide inside the member cavity 30

The feed end 51 carries the feed valve 4.

The member cavity 30 comprises at least one lug or projection 37 arranged to lock the sliding of the dispensing end 41 into the member cavity 30 as long as the pressure on the pressing surface 25 is less than a minimum threshold value.

The pressing surface 25 is arranged to, under the effect of pressure, reduce the interior volume of the pocket 2 by moving towards the bottom wall the dispensing part 23 and the member cavity 30, so that:
the dispensing end 41 slides in the member cavity 30 by sinking in the member cavity 30; considering the lug or projection 37 (which is optional) and/or friction between the inner walls of the member cavity 30 and the end 41 and/or compression of the cavity 30 (for example if the end 41 comprises a piston, the cavity 30 has, then in this case, a spring effect making it possible to avoid the stop 32 described below), the member 31 also moves towards the bottom wall but with an amplitude of movement lower than the amplitude of movement of the part 23 and the cavity 30; and
the member 31 presses the feed valve 4 in its closed position against the feed orifice 124, at least one time (typically the valve 4 begins to rise at the beginning of the motion, then is pressed against the orifice 124 until the pressure inside the pocket 2 falls to a certain level). This facilitates the priming of the device 102.

The dispensing end 41 is slit in its length.

The device 102 comprises a stop 32 located inside the feed duct 6.

The stop is arranged to press against the feed orifice 124 or at least be close to the feed orifice 124 in the absence of pressure on the pressing surface 25.

The feed end 51 is further provided with the stop 32.

In this embodiment the stop 32 is a plug, that is to say it is arranged to plug and close the feed orifice 124 when the stop 32 is pressed against the feed orifice 124.

At rest, that is to say without the device 102 undergoes stress or external force, the stop 32 is pressed against the feed orifice 124. The pressing surface 25 is arranged to, under the effect of pressure, decrease the interior volume of the pocket 2 by moving the dispensing part 23 (and the member cavity 30, so that the dispensing end 41 slides in the member cavity by sinking in the member cavity) so that the member 31 moves its stop 32 away from the feed orifice 124.

In this embodiment, the cavity 8 has a shape of letter T.

The dispensing valve 5 is in the upper bar of the T.

The dispensing valve 5 is in the cap 70.

The seat 105 is in the cap 70.

The portion 11 of the valve 5 is clamped between inner walls of the cavity 8 (inside the cap 70).

To limit the dead volume of the cavity 8, the dispensing head 23 comprises a zone 38 (or volume) “prohibited” in which the fluid to be dispensed can not penetrate.

This further facilitates the priming of the device 102.

This zone 38 is for example an air cavity or an area filled with material, for example PP.

Thus, the cavity 30 is surrounded, in a 360° circumference around the cavity 30, in majority (more than 180°, preferably more than 270°) by the zone 38 and in addition at least by a portion 56 (the lower bar of T) of the cavity 8. This channel 56 is also in the cap 70, but could alternatively be in the insert 71.

The reservoir 13 is not formed by a flexible bag but by rigid walls made of PP.

The reservoir 13 is formed:
by a peripheral space 131 (typically in the form of a hollow cylinder formed by two concentric cylinders) in which a piston 132 (typically annular) moves or slides according to the volume of fluid to be dispensed remaining in the reservoir 13, and
by a central space 133 surrounded by the peripheral space 131 and communicating with this peripheral space 131.

The orifice 124 opens into the central space 133.

There is an opening between the spaces 131 and 133 so that the fluid can pass between these two spaces 131 and 133. This opening is located at the top of the spaces 131 and 133, that is to say above a stop for the piston 132, that is to say that this opening is arranged to allow a fluid passage between the spaces 131 and 133 regardless of the position of the piston 132.

The device 102 comprises a refill connector 35 arranged to allow fluid to be refilled inside the device 102 (more exactly inside the duct 6 and/or reservoir 13) without this fluid passing through the pocket 2 or the dispensing valve 5 or the feed valve 4.

The connector 35 comprises a refill valve 39 which:
at rest is closed, and
is arranged to open when the means 35 are connected to a source of fluid to be dispensed.

The valve 39 opens into the central space 133.

The wall 22 has a wavy shape. This makes it easier to deform and/or to have a spring effect.

In one embodiment of manufacturing method of the device 102, the dispensing valve 5 is mounted in the dispensing cavity 8 by insertion through the outlet 24.

This makes it possible to have a monoblock dispensing head 23 with a lateral dispensing.

It is noted that the piston 132 slides inside the device 102 without deforming the outside of the device 102.

A variant of the device 102 of the second embodiment according to the invention will now be described with reference to FIGS. 15, 16 and 17 only for its differences with respect to FIGS. 12 to 14.

In this variant, the stop 32 is provided with a through hole 33.

The feed duct 6 is provided with a through hole 34.

The stop 32 is arranged to block any flow of fluid through the feed orifice 124 as long as the through hole 33 of the stop 32 does not face the through hole 34 of the feed duct 6.

The through hole 33 of the stop 32 does not face the through hole 34 of the feed duct 6 in the absence of pressure on the pressing surface 25.

The cavity 30 comprises, on its inner walls, a screw thread, and the end 41 is provided with portions inserted in this screw thread.

The pressing surface 25 is arranged to, under the effect of pressure, reduce the interior volume of the pocket 2 by moving, towards the bottom wall 21, the dispensing part 23 and the member cavity 30, so that the dispensing end 41 slides by pivoting (due to the screw thread) in the member cavity 30 by sinking in the member cavity 30.

The pressing surface 25 is arranged to, under the effect of pressure, reduce the interior volume of the pocket 2 by moving the dispensing part 33 toward the bottom wall 21 so that the member 31 pivots on itself and that the through hole 33 of the stop 32 faces the through hole 34 of the feed duct 6, at least one time (for example the time that the pressure inside the pocket 2 falls to a certain level).

A third embodiment of the device 103 according to the invention will now be described, with reference to FIGS. 18 to 21, solely for its differences with respect to the embodiment of FIGS. 12 to 14.

In the device 103, the stop 32 is not a plug, but includes one or more openings 40 for the passage of the fluid.

The device 103 comprises a rod 36.

The refill connector 35 is arranged to:
during a connection of the refill connector 35 to a source 42 of fluid to be dispensed, push the rod 36 to a place upstream of the dispensing valve 5 (upstream of the dispensing valve 5 means along a fluid circulation path between the connector 35 and the valve 5) so as to block a flow of fluid upstream of the dispensing valve 5, preferably so as to plug the feed orifice 124 and/or the dispensing orifice 108, and
during a disconnection of the source 42 from the refill connector 35, pull the rod 36 so that the rod 36 no longer blocks a flow of fluid upstream of the dispensing valve 5, preferably so as to open the feed orifice 124 and/or the dispensing orifice 5.

The rod 36 passes through the feed duct 6 and/or the fluid reservoir 13.

More specifically, the refill connector 35 is arranged to, during a connection of the refill connector to a source 42 of fluid to be dispensed, push the rod 36 (which may be a piston 36) towards the orifice 124 so as to plug the orifice 124 by the rod 36 and/or the stop 32.

One end of the rod 36 carries a plug 74.

Thus, more exactly, in this embodiment, the refill connector 35 is arranged to, during a connection of the refill connector to a source 42 of fluid to be dispensed, push the rod 36 against the stop 32 so as to:
hold the stop against the feed orifice 124 and
plug the feed orifice 124 by the rod 36, more precisely by the plug 74.

Thus, it is possible to refill the reservoir 13 without the fluid being refilled starting in the pocket 2 or to the outlet 24 under the effect of the pressure of the refill.

The rod 36 is located inside the central space 133.

The refill connector 35 is arranged to, when disconnecting the source 42 from the refill connector 35, pull the rod 36 so that the rod 36 moves away from the orifice 124 and does not plug the orifice 124.

The refill connector 35 is arranged to, when disconnecting the source 42 from the refill connector 35, pull the rod 36 so that the rod 36 no longer touches the stop 32 and no longer blocks the displacement of the stop 32.

The pocket 2 initially comprises a vacuum or a depression with respect to the contents of the reservoir 13.

The device 103 may comprise a lid or a cap (impervious to gas and blocking any passage of gas, and not illustrated) so that the stop 32 is located between this lid or cap and the orifice 124.

The pressing surface 25 is arranged to, when pressing on the pressing surface 25, push the member 31 towards the orifice 124 so that the stop 32 pushes the rod 36 and moves the rod 36 away from the orifice 124.

Thus, the stop 32 is arranged to pierce or open the lid or cap. This is of interest especially when the pocket 2 initially contains a vacuum so as to prime the device 103.

The lower part of the wall 22 is pinched or clamped between the guide element 26 and the bottom wall 21, so that this zone of pinching or clamping of the wall 22 is sealed and does not let fluid pass between the guiding element 26 and the bottom wall 21.

Note that this embodiment comprises only one valve 5 between the pocket 2 and the outlet 24, as in most of the illustrated embodiments of the present description.

With reference to FIG. 22, in a variant to the embodiments 102 and 103 of FIGS. 12 to 21, the portion 11 of the valve 5 is not clamped solely by the cap 70. In this variant, the valve 5 (More precisely the portion 11) is held between the inner walls of the cavity 8 by clamping between the cap 70 and the insert 71.

Thus, in this variant, there is the large opening 205 or large cavity 62 (for portion 11), the small opening 224 or small cavity 61 and the element 29 described with reference to FIGS. 1 to 11.

The small opening 224 (or small cavity 61) is included inside the large opening 205 (or large cavity 62).

The upper part of the wall 22 is pinched or clamped between the insert 71 and the cap 70 so that this zone of pinching or clamping of the wall 22 is sealed and does not let fluid pass between the insert 71 and the cap 70.

The wall 22 is an independent piece without continuity of material with the dispensing part 23.

For the manufacturing method according to the invention of this variant, the valve 5 is placed on the insert 71, which has a device 72 for wedging or holding (typically a pin, a cavity, a dovetail or a light tightening if the valve 5 is moved by sliding perpendicular to the axis of insertion of the insert 71 in the cap 70) before insertion and translation in the cap 70 of the assembly formed by the insert 71 and the valve 5.

The top of the device can be removable and fit into the reservoir 13, in particular the skirt 26 can be cut (do not act as a body and/or reservoir) and be provided with means of connection to the reservoir 13.

A fourth embodiment of the device 104 according to the invention will now be described, with reference to FIGS. 23 and 24, solely for its differences with respect to the embodiment of FIGS. 1 to 3.

The interior volume of the pocket 2 is delimited at least in part by the deformable wall 22 and by the bottom wall 21.

The bottom wall 21 is integral with an end piece 89 also called “eye” 89.

The device 104 comprises the reservoir 6, 13 delimited by the walls 14 which are fixed to the end piece 89, or more precisely a flexible bag 14 welded to the end piece 89.

The device 104 comprises the feed orifice 124 connecting the reservoir 13 to the interior volume of the pocket 2.

The pocket 2 is located inside the reservoir 13.

The dispensing part 23 carries the dispensing orifice 108 and is at least partly inserted into the end piece 89 on the side of its dispensing orifice 108.

The device 104 comprises the pressing surface 25. The surface 25 is arranged to, under the effect of pressure (and by direct contact between the surface 25 and the wall 22, without passing through the dispensing part 23), reduce the interior volume of the pocket 2 by deforming the deformable wall 22.

The pressing surface 25 does not surround the outlet 24.

The outlet 24 is arranged to distribute fluid in a direction substantially parallel to the pressing surface 25.

The dispensing part 23 is not located on a top of the concave shape of the deformable wall 22, that is to say on the upper part of the wall 22.

The pressing surface 25 is arranged to, under the effect of pressure, reduce the interior volume of the pocket 2 by deforming (and moving) the deformable wall 22 without moving the dispensing cavity 8 and the dispensing valve 5 towards the bottom wall 21.

The cavity 8 extends along an axis perpendicular to an axis which successively passes through the deformable wall 22, the pocket 2 and the bottom wall 21. The cavity 8 is part of the dispensing part 23 which is placed or nestled inside the eye 89.

The feed valve 4 is in the pocket 2 and the dispensing valve 5 is in the dispensing part 23.

The dispensing valve 5 is connected to the feed valve 4 with a “passage channel 111” at the junction zone, more precisely a groove 111 in the valve is connected to the groove 88 or 18 in the cavity 8 (we can reverse the realization of the grooves on the flexible part or rigid part, the seal is achieved by crushing the flexible part).

The dispensing valve 5 is held by clamping in the dispensing channel between portions of the walls of the dispensing channel which surround the groove 88 or 18.

The dispensing valve 5 comprises its portion 11 held by clamping between the inner walls of the cavity 8 at the large opening 205 (or the large cavity 62) and by clamping a flange 76 parallel to the direction of elongation of the cavity 8, typically by clamping between the part 23 and other piece of the device 104 as, for example, a part integral with the bottom wall 21, more precisely the eye 89. The flange 76 goes around except at the passage of the liquid, it allows a seal between parts 89 and 23; alternatively, this seal can also be obtained by clamping or welding between the two parts 89 and 23.

A plug 77 is arranged to pass between two positions:
a closed position (illustrated in FIG. 23) in which a portion 771 (stud) of the plug 77 is inserted in the outlet 24 (more precisely in the opening 224 (or cavity 61)) so as to plug the outlet 24, this stud 771 is closed on a seat 156, the distance between the closing of the dispensing valve 5, more precisely the portion of the seat 105 to the outlet 24, and the seat 156 is at a distance of less than 6 mm even less 4 mm
an open position (illustrated in FIG. 24) in which this portion 771 of the plug 77 is no longer inserted into the outlet 24 (more precisely in the opening 224 (or cavity 61)) so as not to plug the outlet 24. The plug 77 comes from the molding with the part 23

The pocket 2 is located inside the reservoir 13.

The device 104 comprises the feed valve 4 which, in an open state, allows a fluid passage of the feed duct toward the inside of the pocket 2 through the feed orifice 124, and in a closed state, does not allow a fluid passage of the feed duct toward the inside of the pocket 2 through the feed orifice.

The feed valve 4 is integral with the dispensing valve 5.

The feed valve 4 and the dispensing valve 5 are in a single piece of a single material.

The feed valve 4 is located inside the pocket 2.

The dispensing valve 5 is located outside the pocket 2.

The dispensing valve 5 is located in the device 104 according to an assembly by insertion through the dispensing orifice 108 or the large opening 205 (or large cavity 62). The dispensing valve 5 is kept blocked, without any possible exit from the cavity 8 on the side of the dispensing orifice 108 or of the large opening 205, by means of a blocking by the end piece 89.

The dispensing part 23 comprises a wall located outside the end piece 89 and which:
is visible from outside the device 104
runs along the dispensing valve 5 from the outlet 24
is of constant thickness or substantially constant.

A variant of the fourth embodiment of the device 104 according to the invention will now be described with reference to FIGS. 25 to 28 only for its differences with respect to the embodiment of FIGS. 23 to 24.

The pressing surface 25 comprises the wall 22.

The pressing surface 25 is part of the dispensing part 23.

The outlet 24 is arranged to distribute fluid in a direction substantially perpendicular to the pressing surface 25.

The cavity 8 extends along an axis parallel to an axis which passes successively through the deformable wall 22, the pocket 2, and the bottom wall 21.

The dispensing valve 5 comprises its portion 11 maintained (preferably by clamping) between the part 23 (which forms a distributing wall) and another part of the device 104 such as a part integral with the bottom wall 21. The reservoir 13 and its wall 14 is closed in part by a cover 222 comprising the part 23, the wall 22 and the outlet 24 and partly by the bottom wall 21. The dispensing orifice 108 is a passage formed by a part of the wall of the bottom 21 and cover 222 (assembly).

The cover 222 and the bottom wall 21 extend in the same direction.

The rib 15, arranged to limit a crushing of the reservoir 13 and to limit an amplitude of reduction of the volume of the reservoir 13, is formed by a part, comprising the cavity 8, of the part 23.

The flexible wall 14 is made of elastomer or plastomer, for example thermoplastic polyolefin (TPO).

The wall 14 is fixed to the part 23.

Typically, a bead 78 of the cover 222 is folded over the wall 14, preferably over a whole periphery of the wall 14, so as to combine the wall and fix it with the part 23, typically by ultrasonic welding or by a connection folded by ultrasound. The reservoir having a fairly thin wall at the portions in contact with the fluid or product or liquid to be dispensed can be welded directly by ultrasound.

In order to fill the remaining space of the small opening 224 of the cavity 8 (or the small cavity 61) towards the outlet 24, the dispensing valve 5 has an end 122 to join flush with the dispensing surface 28 near the outlet 24. Optionally the end 122 may be in contact on a second seat 155 towards the orifice 24, the valve 5 may have a spring effect through a cavity 121, the cavity 121 may trap an air bubble. Preferably the liquid outlet is preferred on one face, the end 122 having a prismatic shape. The closure of the dispensing valve 5 and more precisely the portion of the seat 105 to the outlet 24 is at a distance of less than 6 mm even less than 4 mm from the outlet 24.

The cavity 8 is located inside the reservoir 13 and/or the duct 6.

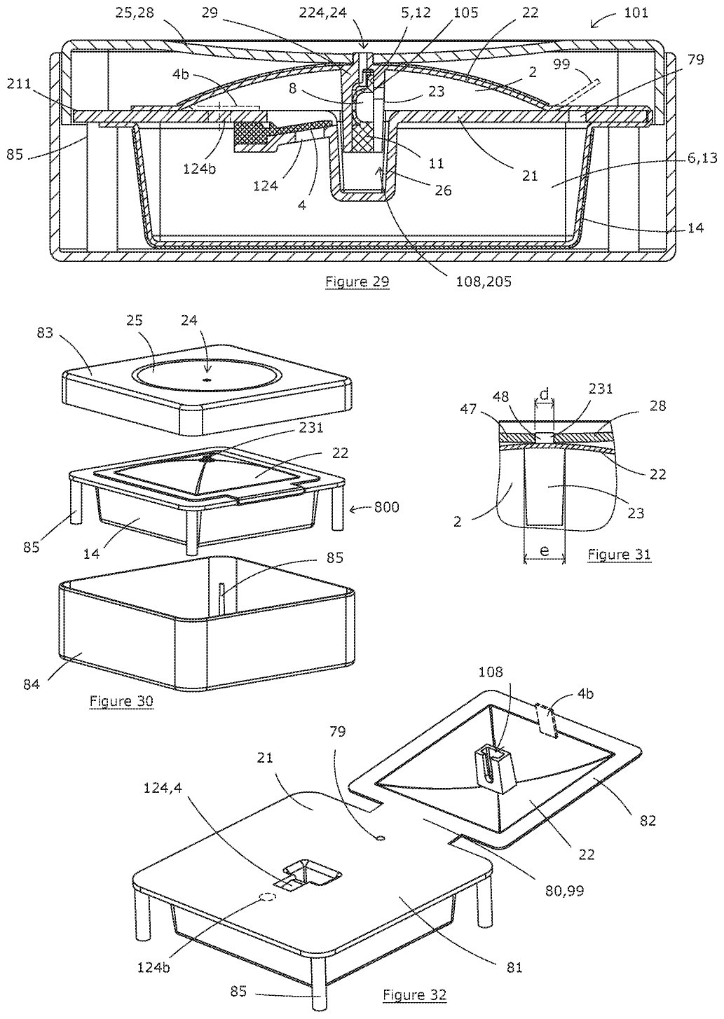

A variant of the first embodiment of device 101 according to the invention will now be described, with reference to FIGS. 29 to 32, solely for its differences with respect to the embodiment of FIG. 6.

According to an independent aspect of the previously described aspects of the invention, the interior volume of the pocket 2 is delimited at least in part by:
a first piece 81 comprising the bottom wall 21 and the feed orifice 124, and optionally the valve 4; if it is present, the valve 4 is mounted against the feed orifice 124; the wall 21 is arranged so that only two exits allow access to the interior of the reservoir 13: the orifice 124 and a filling hole 79.
a second piece 82 comprising the wall 22, and also preferably a periphery 80 disposed around the wall 22.

The interior volume of the reservoir 6, 13 is delimited at least in part by:
the reservoir walls 14 and
the bottom wall 21.

One of the reservoir walls 14 and the bottom wall 21 is assembled (for example by a flexible tongue) to the deformable wall 22 in a single piece of a single material, that is to say:
the reservoir walls 14 and the deformable wall 22 are assembled in a single piece of a single material (in the case of FIG. 29 and FIG. 30), or
the bottom wall 21 and the deformable wall 22 are assembled in a single piece of a single material (case of FIG. 32).

The feed orifice 124 and the valve 4 in this orifice 124 can be replaced respectively by the feed orifice 124b (slightly offset on the wall 21 with respect to 124) and the valve 4b integral with the wall 22.

Note that the cartridge 800 has an edge 211 of the bottom wall 21 to cooperate with ribs 85 of the case 84 and/or the edge 211 is provided with feet 85 to cooperate with the bottom of the case 84. The cartridge 800 is maintained in the case 84 by the bottom wall 21.

The cartridge is inserted through the top of the case after removing the mobile dispensing wall 83.

The invention relates to a method of manufacturing a device according to the invention, in which the reservoir 13 is filled with the fluid to be dispensed (preferably liquid or cream or gel or paste or a mixture thereof) by filling means.

The pocket 2 may communicate with the outside of the device so that the gas contained in the pocket 2 can be expelled easily outwardly until the product is raised downstream of the feed hole 124, 124b in two ways:
either during filling with the deformable wall 22 opened (filling under pressure or not)
or if the wall 22 is closed (other variant) with a pressure on the reservoir and/or a filling under pressure associated with means so that the dispensing valve is in the open or almost open position, so that the air can exit easily with a slight gas overpressure in the pocket 2. So we have means to reduce the closing force of the dispensing valve, for example in the case of FIG. 41 or 42, just have a tool external which will push the rod 58 towards the inside of the pocket 2.

There are means not shown for pressing the reservoir and/or opening and/or pressing on the dispensing valve 5.

Before assembling the deformable wall 22 and the bottom wall 21, so that during filling:
the fluid filling the reservoir 13 penetrates through the hole 79 but can not leave the reservoir 13 through the hole 79 (for example by having no interstitial space between the fluid filling means inserted into the hole 79 and the around this hole 79)
the gas initially inside the reservoir 13 can not leave the reservoir through the hole 79 (for example by having no interstitial space between the fluid filling means inserted in the hole 79 and the periphery of this hole; hole 79)
the fluid filling the reservoir 13 and the gas initially inside the reservoir 13 can escape from the reservoir 13 only through the feed orifice 124 or 124b
and preferably the pocket 2 is not yet formed so that the valve 5 or any other part does not block the fluid outlet through the valve 4
optionally if the pocket 2 is closed a tool can come to open the dispensing valve 5 so as to facilitate the expulsion of air outside the device.

This filling is carried out until the fluid to be dispensed goes beyond the valve 4 and/or the feed orifice 124 with respect to the reservoir 13 or reaches the interface between the valve 4 and the seat of feed.

In the variant where the pocket 22 is closed, the filling hole 79 is not covered by the welding of the deformable pocket 22 but can be closed by the welding of a tongue 99 coming from molding with the deformable pocket 22 after filling. Advantageously, the filling hole 79 may be connected to a filling channel protruding from the bottom wall 21. In another variant, the bottom wall 21 has a skirt forming a lateral part of the reservoir 6, on this skirt is disposed the hole filling member 79 which can be closed by the tongue 99 of the wall 22 and making an angle of the order of 90° with the bottom wall 21.

Then, in this embodiment of the method according to the invention, the bottom wall 21 and the deformable wall 22 are assembled so as to form the pocket 2 and the hole 79 is plugged. The closure of the hole 79 and the assembly can be done simultaneously. For example, it is possible to fix (for example by ultrasonic welding) the periphery 80 on the wall 21 so that the perimeter 80 fixed closes the hole 79.

Thus, thanks to this embodiment of the method according to the invention, the fluid passage to be dispensed by the valve 4 can be very easily primed.

Preferably, the second portion 82 also comprises the part 23 and/or the cavity 8 and/or the valve 5.

The two assembled parts 81, 82 are then enclosed between a mobile dispensing wall 83 comprising the surface 25 and a case 84.

The movable dispensing wall 83 comes into contact with the wall 22 and/or the part 23.

Feet or ribs 85 integral with the first portion 81 and/or the case 84, are arranged to maintain the position of the fixed wall 21 relative to the case 84, even if the volume of the reservoir 13 is reduced as a result of a fluid outlet out of the reservoir 13.

In this variant of device 101, the device 101 comprises the ring 28.

The dispensing ring 28 is superimposed on the wall 22, and is preferably engaged or clipped on the dispensing part 23 via a connecting stud 231 secured to the wall 22 and/or the part 23 as in the case of FIG. 4. (Less preferably it is possible to reverse: the connecting pin 231 may be on the dispensing ring 28 and this pin enters the dispensing part 23). With reference to FIG. 31, it will be noted that the width d of the stud 231 is smaller than the width e of the part 23, preferably by a factor of at least 1.5 times less than d<1.5

The pressing surface 25 is located on this ring 28.

The interior volume of the pocket 2 is delimited at least in part by the deformable wall 22 and by the bottom wall 21.

The device 101 comprises the reservoir 13 delimited by the reservoir walls 14 and the bottom wall 21.

Before assembly of the wall 22 and the wall 21, the bottom wall 21 is arranged so that only two exits allow access to the interior of the reservoir 13: the feed orifice 124 and the filling hole 79.

At least one of the reservoir walls 14 and the bottom wall 21 is connected to the deformable wall 22 in one piece.

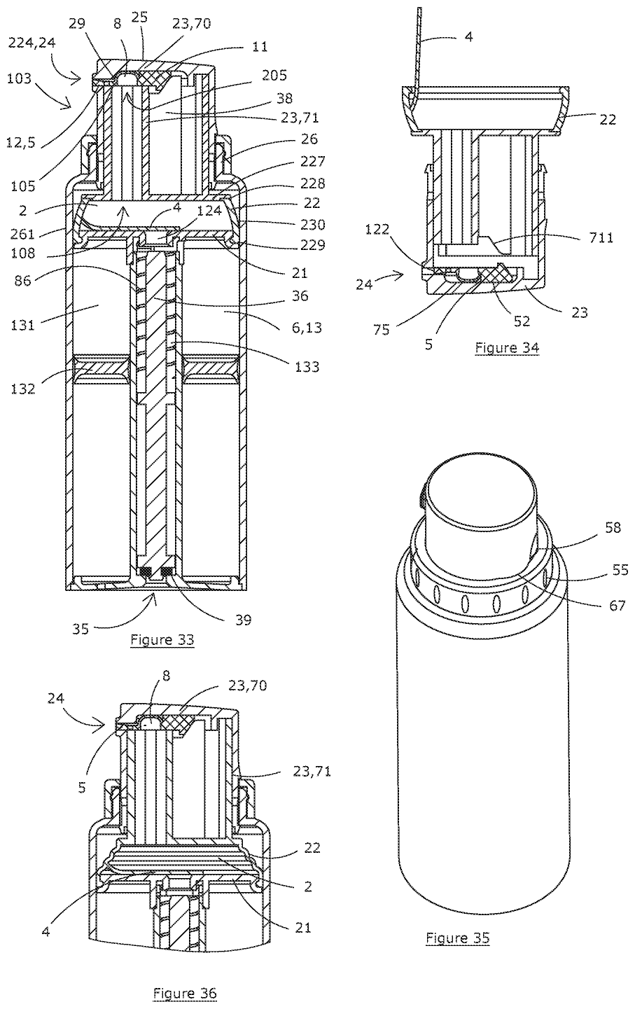

A variant of the third embodiment of the device 103 according to the invention will now be described, with reference to FIGS. 33 to 35, solely for its differences with respect to the embodiment of FIG. 22.

The outlet 24 is arranged to distribute fluid in a direction substantially perpendicular to the single axis of translation of the part 23 and/or substantially parallel to the pressing surface 25.

There is a continuity between the deformable wall 22 and at least a part (more exactly the insert 71) of the dispensing part 23. The wall 22 and at least a part (more precisely the insert 71) of the part 23 are grouped into a single piece of a plurality of materials, for example by overmolding or bi-injection.

This variant of device 103 does not include member 31 or stop 32.

The feed valve 4 closes, in its closed position, the orifice 124.

The valve 4 is located inside the pocket 2.

The valve 4 is a tongue secured to the wall 22, and made of the same material as the wall 22. The valve 4 is arranged to be pressed against the orifice 124 and the feeding seat, when the wall is not yet assembled to the bottom wall (FIG. 34), the tongue of the valve 4 is extends substantially perpendicularly to the elongation direction of the valve 4 in its closed position and when assembled, pressed against the feeding seat. The valve 4 thus comprises a tongue integrated in the deformable wall 22.

The rod 36 is integral with one of its ends of the valve 39 which is a simple seal.

The refill connector 35 is arranged to:
when connecting the refill connector 35 to a source 42 of fluid to be dispensed, push the rod 36 so as to move the seal 39 away from the connector 35 so as to create a fluid passage opening from the source 42 to the interior of the reservoir 13 (more precisely towards the interior of space 133), and
when disconnecting the source 42 from the refill connector 35, a spring 86 or other biasing means pushes the rod 36 so as to return the seal 39 towards the connector 35 so as to close the passage opening of fluid from the source 42 to the interior of the reservoir 13 (more precisely towards the interior of the space 133).

Note that the deformable wall 22 is not movable in the cap 70. There is no part of the mobile pocket function in the cap 70. The cap 70 is mounted superimposed on the flexible wall 22. The wall 22 is a bellows 230 with an upper edge 228 connected to the cap 70 or to the insert 71 in continuity of material or over-molding or bi-injection, and a lower edge 229 maintained in pressure between the bottom wall 21 and a skirt 261 delimiting at least in part the reservoir 13. The junctions and/or connection with the edges 229 and 228 are sealed. The cap 70 may comprise shoulders 227 in order to adjust the deformation forces of the wall 22 and/or to optimize the size of the pocket 2

With reference to FIG. 34, the valve 5 is placed in a sliding cavity 52 of the cap 70 (and/or of the insert 71 in the variants of cavity 52) and then it is moved transversely towards the outlet so as to the end 122 is flush with the outlet 24. This movement can be done by an assembly tool and/or by the insert 71 (and/or the cap 70 in the same cavity variants 52) provided with means for example a protrusion 711. The protrusion 711 can also be in the cap 70.

The deformable wall 22 does not comprise any movable part inside the dispensing part 23.

The dispensing part 23 comprises the cap 70 and the insert 71, the insert 71 being inserted into the cap 70.

The dispensing valve 5 is held in the cavity 8 by clamping between the cap 70 and the insert 71.

The dispensing valve 5 may be housed in a cavity formed by the assembly of the insert 71 and the cap 70, it can be housed in a channel formed in the insert 71, the valve 5 can be moved to the outlet 24 by sliding in this sliding channel 52. The dispensing valve is held in the axis of the sliding cavity 52 by a stop 75 and the protrusion 711.

There is no space between an inner wall of the cap 70 and an outer wall of the insert 71.

The cap 70 and the insert 71 are mounted in direct engagement.

The insert 71 comprises a rib or protrusion 711 arranged to drive the dispensing valve 5 into its cavity 8 during insertion of the insert 71 into the cap 70.

The deformable wall 22 is secured to the dispensing part 23 by overmolding or bi-injection of one on the other.

With reference to FIG. 35, the device 103 comprises means 55, 58, 67 enabling the device to have two positions:
a position for dispensing fluid
a position blocking the fluid dispensing.

More exactly, the device 103 comprises a ring 55.

A lug or thickening 58 is integral with the dispensing part 23 (more exactly the cap 70) or the ring 55, and a passage 67 is integral with the ring 55 or the dispensing part 23.

When the ring 55 is rotated so that the lug 58 faces the passage 67, this allows the displacement of the dispensing part 23 and therefore the fluid dispensing.

In all the other positions of the ring 55, the dispensing part 23 and therefore the fluid dispensing are blocked.

The cavity 8 extends in a direction of elongation perpendicular or substantially perpendicular to the elongation direction of the device 103.

The cavity 8 is sealed relative to the outside of the device except for its outlet 24.

A variant of the third embodiment of the device 103 according to the invention will now be described with reference to FIG. 36 only for its differences with respect to the embodiment of FIGS. 33 to 35.

In this variant, the wall 22 and at least part of the part 23 (more exactly the insert 71) are the same part in the same material.

A variant of the third embodiment of the device 103 according to the invention will now be described, with reference to FIGS. 37 to 39, solely for its differences with respect to the embodiment of FIGS. 33 to 35.

The spaces 131 and 133 are merged into a single space.

In this variant, the device 103 comprises a plurality of (preferably at least three) cavities 8 each comprising a valve 5 as described above and opening onto an outlet 24 as previously described with reference to FIGS. 1 to 5.

In this variant, the ring 28, as previously described with reference to FIGS. 1 to 5, surrounds the outlets 24.

The outer surface of the ring 28 carries a sponge or fabric or fibers or impregnation means 832 arranged to imbibe the fluid exiting through each outlet 24.

The mobile dispensing wall 83 is in the form of an applicator. The applicator 83 is removable, and the impregnating portion 832 is removable. The applicator 83 can be sinking and tilting thus has a set 831 with the top of a case 84 delimiting at least part of the reservoir 13. In another embodiment the set 831 can be removed or reduced to obtain guidance of the applicator 83.

The multiplicity of the outlets 24 makes it possible to correctly impregnate the impregnation means 832 in a more homogeneous manner.

Each outlet 24 is arranged to distribute fluid in a direction substantially parallel to the single axis of translation of the part 23 and/or substantially perpendicular to the pressing surface 25.

The dispensing part 23 is in one part, and therefore does not include the cap 70 and the insert 71.

In this variant, the device 103 does not include a refill connector 35.

The dispensing part 23 is not located on a top of the concave shape of the deformable wall 22, that is to say on the upper part of the wall 22.

The wall 21 is located on a top of the concave shape of the deformable wall 22, that is to say on the upper part of the wall 22. The deformable wall 22 is closed by a wall 46 provided with an edge 44 substantially flat, the wall 46 carries the dispensing part(s) 23 placed preferably outside the pocket 2.

The reservoir 13 and the pocket 2 each comprise a sponge 87.

The sponge 87 may be a polyurethane or polyester foam or PE and PET assemblies.

The device 101 is provided with a clamping means 90 so as to retain the extension over time of the sponge of the reservoir 13 and/or to act manually by forcing the product to come out.

The device 101 comprises a plurality of outlets 24 and a plurality of dispensing orifices 108.

The dispensing part 23 comprises a plurality of dispensing assemblies, each dispensing assembly comprising a dispensing cavity 8 in which is located a dispensing valve 5 which, in an open state, allows a fluid passage from the inside of the pocket 2 to one of the outlets 24 which is associated with it via one of the dispensing orifices 108 which is associated with it and by its dispensing cavity 8, and, in a closed state, does not allow a fluid passage from the inside of the pocket 2 to its associated outlet via the dispensing orifice 108 associated therewith and its dispensing cavity.

The deformable wall 22 has a concave shape oriented towards each dispensing orifice 108.

The outlets 24 open onto a sponge or cloth or impregnation means 832 of the product to be dispensed.

The interior volume of the pocket 2 comprises a sponge or impregnating means 87 of the product to be dispensed.

The device 101 comprises:
the reservoir 13
The feed orifice 124 connecting the reservoir 13 to the interior volume of the pocket 2.

The interior volume of the reservoir 13 comprising a sponge or impregnation means 87 of the product to be dispensed.

The device 101 comprises the adjustment means 90 arranged to reduce the volume of the volume of the reservoir 13 without touching the pressing surface 25, comprising a screw thread and/or a spring.

Note that the part 23 is outside the pocket 2.

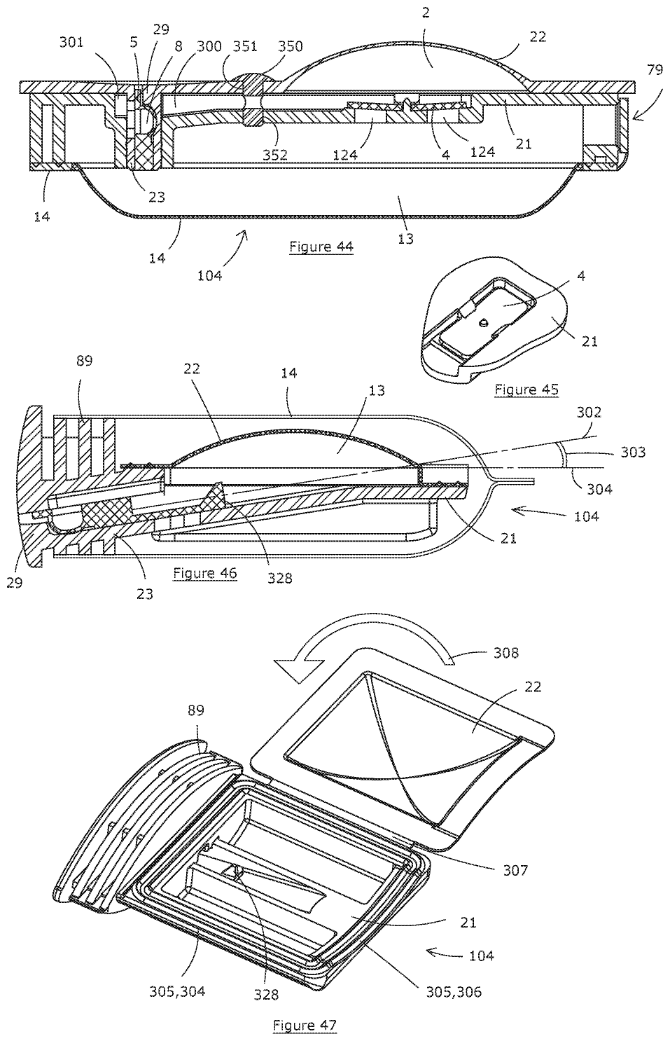

A variant of the third embodiment of the device 103 according to the invention will now be described with reference to FIG. 40, but only for its differences in the embodiment of FIGS. 37 to 39 combined with FIG. 30.

As with the device of FIG. 30, this device comprises a refill 800. This refill is inserted through the bottom of the case 84 to connect to the mobile dispensing wall 83. The movable dispensing wall 83 is mounted floating in the case 84 with a axial and transverse play. The mobile dispensing wall 83 is trapped between the case 84, more precisely between a shoulder 841 of the case and a ring 91 mounted in force in this case 84. In order to assist the guide, a guide element 836 (such as one or more cylinder (s)) can be made on the movable dispensing wall 83 to receive the part 23.

The movable dispensing wall 83 may sink and/or incline, an element may be added to the pocket 2 to have more inclination than the sinking.

The refill 800 is blocked in the case 84 by the edge 211 of the bottom wall 21 of the refill 800, this edge 211 is housed between the plug 260 and the shoulder 841. The refill 800 has connection means 47, 48 to connect to the movable dispensing wall 83 which may be provided with a fabric of an impregnation means or a sieve 832 crimped or welded in a rigid piece 833 which fits on the edge of the mobile wall dispensing 83. The assembly 832 and 833 can be removed from this mobile dispensing wall 83. The refill 800 can have foolproofing means with the case 84 and/or the mobile dispensing wall 83.

A variant of the fourth embodiment of the device 104 according to the invention will now be described, with reference to FIGS. 44 and 45, solely for its differences with respect to the embodiment of FIG. 25.

The bottom wall 21 is integral with a skirt forming a lateral portion of the reservoir 13; on this skirt is arranged the filling hole 79 which can be closed and making an angle of the order of 90° with the bottom wall 21.

The wall 14 of the reservoir 13 is welded to the part forming the bottom wall 21 (as illustrated in FIG. 44) and/or the wall 22 (not shown), typically by ultrasound or high-frequency or thermal welding.

The wall 14 may consist of a single material, or as illustrated in FIG. 44, of a plurality of materials, one of which is flexible at the center and a rigid one at the fixing of the wall 14 with the wall 21 and/or 22.

The film 14 can be inflated by a hot deformation operation or by overpressure, to soften it and/or give it its shape.

The valve 4 is a simple flat flexible tongue. In particular, the valve 4 does not include a foot or protuberance emerging from the flat shape of the tongue and sinking into the bottom wall 21. This improves the flexibility of the valve 4 and facilitates priming. In addition, this allows a larger passage with two orifices.

The valve 4 is preferably clipped to the bottom wall 21.

The valve 4 is fixed laterally with clips and/or by its middle. The valve 4 is pressed against two feed orifices 124 surrounding a middle of the valve 4 and is curved so that this middle is in the middle of the hollow formed by the valve 4.

The valve 5 is in the cavity 8 which is formed by a single piece.

The valve 5 is located between an end 300 of the pocket 2 and a through hole 301 through the part 23 and connecting the pocket 2 to the cavity 8. This allows demolding and manufacturing of the piece 23 easier. There is therefore a fluid communication between the parts 300 and 301 slightly set back from the plane of FIG. 44.

The reservoir 13 and its wall 14 is mainly closed by the part forming the bottom wall 21.

The cavity 8 and the part 23 fit into the bottom wall 21.

The dispensing valve 5 is maintained in the dispensing part 23 (or in a non-illustrated variant between the dispensing part 23 and the bottom wall 21).

The cavity 8 and the dispensing part 23 are driven into the bottom wall 21.

The dispensing valve 5 has at least one of its points located less than 6 mm from the outlet 24.

The dispensing part 23 and the deformable wall 22 form a single piece without discontinuity of material.

The cavity 8 comprises the small opening and the large opening, the passage between the large opening 205 and the small opening 224 being made by the filling element 29 of the cavity 8.

The wall 21 and the part 23 are drilled to make holes arranged to allow a filling of the reservoir 13 from outside the device 104 through these holes. These holes are plugged by two plugs 351 or 352 or a single double plug 350. According to the embodiment illustrated in FIG. 44, a double plug 350 (ie a single integral part) is drilled to make a hole allowing a fluid passage between the part 23 and the wall 21 in the pocket 2 and/or in a duct connecting the pocket 2 to the cavity 8.

This device 104 may be filled according to a filling process during which the pocket 2 is in the open air or in depression.

The cap 351 or the upper part of the plug 350 closes the interface between the outside of the device according to the invention and the pocket 2.

The cap 352 or the lower part of the plug 350 closes the interface between the pocket 2 and the reservoir 13.

As in the case of FIG. 32 (where when pressing the valve 4 to open it, in all cases the pocket 2 is in the open too), the process of filling in this embodiment comprises a step of filling the reservoir 13 with the fluid to be dispensed while the pocket 2 communicates with the outside of the device according to the invention without passing through the valve 5, typically being connected to the atmospheric pressure and/or outside of the device according to the invention and/or being connected to a source of depression.

Alternatively, the plug 351 may be alone (i.e. in an embodiment without plug 352), only for, in an independent step, filling the pocket 2.

In conclusion according to the invention there can be a step of filling at least part of the pocket 2 while it is open (ie atmospheric pressure or depression, in communication with the outside of the device according to the invention without passing through the valve 5), either in the same step of filling the reservoir 13, or before or after the step of filling the reservoir 13 (case with a plug 351 of the pocket).

A variant of the fourth embodiment of the device 104 according to the invention will now be described with reference to FIGS. 46 and 47 only for its differences with respect to the embodiment of FIG. 23.

The part 23 and the wall 21 are in only one and same piece without discontinuity of material.

The end piece 89 and the part 23 are in only one and same piece without discontinuity of material.

The end piece 89 and the wall 21 are in only one and same piece without discontinuity of material.

The cavity 8 has an oblique inclination direction 302 forming an angle 303 (preferably at least 3°, preferably at least 6°, typically equal to 9±2°) with respect to at least one laying plane 304 of the wall 22 on the part forming the bottom wall 21, for fixing the wall 22 on the wall 21. This allows a facilitated insertion of the valve 5 in the cavity 8.

The laying zone 305 between the wall 22 and the part forming the bottom wall 21 is not perfectly flat but comprises:
a plane 304, and
a clearance 306 at the intersection between the elongation direction 302 of the cavity 8 and the laying zone 305.

The laying zone 305 of the wall 21 is preferably made of a material that is more rigid than the wall 22. This makes it possible to facilitate the welding by ultrasound or high frequencies.

The wall 22 is joined to the wall 21 by a fold zone 307, the laying of the wall 22 being applied to the part forming the bottom wall 21 as shown in FIG. 47 by a fold 308 of the fold zone 307 by folding the wall 22 on the part forming the bottom wall 21.

The valve 5 is integral with a fin 328 so that the fin 328 is located between the valve 5 and the wall 22. This fin 328 extends substantially perpendicular to the elongation direction of the cavity 8. This fin 328 allows to avoid the accidental superposition of a plurality of valves 5 one on the other in the cavity 8 during the automatic assembly of the valve 5 during the manufacture of this embodiment of the device according to the invention.

The part integral with the valve 5 and connecting the valve 5 to the fin 328:
initially, forms an angle whose apex points in a direction opposite to the bottom wall when the valve is placed on the bottom wall before its insertion into the cavity 8, and
is flat in a cutting plane (of FIG. 46), by constraining the direction of elongation of the cavity 8, after insertion of the valve 5 into the cavity 8.

This allows a better holding of the valve 5 in the cavity 8.

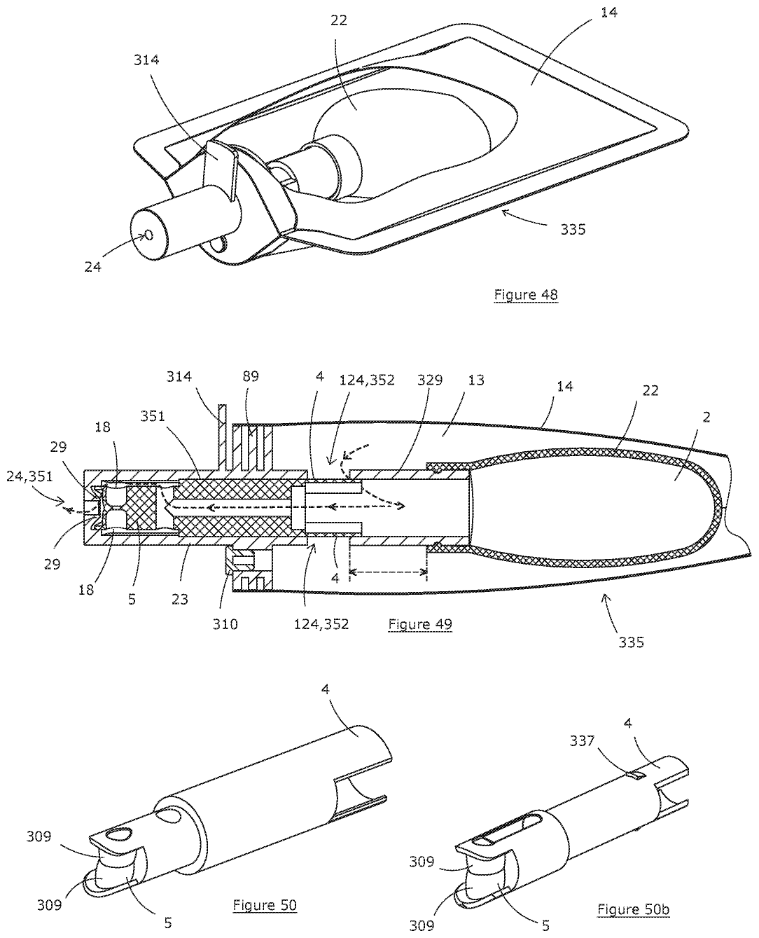

A fifth embodiment of the device 335 according to the invention will now be described, with reference to FIGS. 48 to 52, solely for its differences with respect to the embodiment of FIG. 23.

In this embodiment, the pocket 2 forms a pear.

In FIG. 48, a part of the wall 14 is erased to make it possible to distinguish the wall 22.

The valve 5 is mounted in the cavity 8 by insertion on the side of the dispensing orifice 108.

Part 23 and part 89 are in one and the same piece without discontinuity of material.

The valves 5 and 4 are integral and formed of one and the same piece, typically forming a tube of valve 4, 5 shown in FIG. 50.

At a first end of this tube of valves is the valve 5, comprising two tongues arranged to approach one another in the open position of the valve 5, these two tongues being separable by elements (pocket type or other) arranged to exert on these tongues a restoring force bringing the valve 5 from its open position to its closed position. For example, each tongue of the valve 5 is integral with a pocket 309, and the two pockets 309 are in contact with each other between these two tongues.

At a second end of this tube of valves is the valve 4, comprising two tongues arranged to approach one another in the open position of the valve 4.

The device 335 is equipped (preferably on the end piece 89) with a stopper 310 plugging an orifice opening on the inside of the reservoir 13. This stopper 310 makes it possible to fill the reservoir 13.

With reference to FIG. 51, part 23 forms a spout 311 in which the cavity 8 is located.

The spout 311 carries a tongue 314, also called stop 314. The element 314 is substantially perpendicular to the spout 311.

The part 23 and the reservoir 13 are mounted inside a case 312, 313. This case is formed by two parts respectively 312 and 313.

The part 312 is made of a material without discontinuity of material.

The part 312 comprises a wall 316 running along the outside of the wall 14.

The part 312 comprises a head 315.

The part 313 comprises a wall 321 running along the outside of the wall 14.

The spout 311 is mounted by insertion into the head 315 from the inside of the case 312, 313 before assembly of the two parts 312 and 313. After the insertion of the spout 311 in the head 315, the two parts 312 and 313 are assembled in order to enclose the part 23 and the reservoir 14. Thus, the element 314 is held between the head 315 on one side and the wall 321 and/or the part 89 on the other side.

An applicator 317 is mounted (typically clipped) on the head 315.

A seal 318 is compressed between the spout 311 and the applicator 317 in an axial direction, ie parallel to the direction of elongation of the spout 311. The applicator 317 comprises a massaging element 319 preferably of metal or plastic, a brush 319, a foam 319, and/or a paint brush 319, etc.

The applicator 317 is clipped on the head 315 of the case 312, 313.

The seal 318 is a separate part of the head 315, or is overmolded on the head 315 and integral with the head 315.

The pocket 2 is connected to the dispensing part 23 by being attached to a tube 329.

More exactly, a pear-shaped end piece of the pocket 2 is depressed (preferably nested by force fitting) on or in the tube 329.

The tube 329 is part of the dispensing part 23.

The tube 329 forms one of the ends of the dispensing part 23.

The length of this tube 329 is adjustable according to the embodiment in question, in particular as a function of the size of the reservoir 13. For example, the scale of FIG. 49, the page of which would be printed on A4 paper, is about 2 times the actual size of the device 335.

The pocket 2 is blown, for example of polyolefin material.

The seal 318 may be secured to and/or overmoulded on the head 315 or the applicator 317.

The applicator 317 is clipped to the head 315. The applicator 317 comprises one or more buttons 331 arranged to unclip the applicator 317 relative to the head 315.

In a variant not shown, the pocket 2 is formed by the same piece as the end piece 89 and/or the dispensing part 23, without material discontinuity. For example, the pocket 2 may be formed:
by a rigid or flexible bottom wall 21 integral with the end piece 89 and/or the dispensing part 23, without discontinuity of material, and
by a flexible wall 22 (thin thickness) integral with the bottom wall 21 without discontinuity of material, and connected to the bottom wall by a fold 307 as in the case of the previous FIG. 47. However, unlike FIG. 47, the fold 307 is preferably located opposite the end piece 89 relative to the pocket 2.

In a non-illustrated variant of FIG. 49, the outlet 24 is widened so as to have a cross-sectional area or a diameter equivalent to that of the cavity 8. In this variant, the valve 5 can be inserted in the cavity 8 through the outlet 24. In addition, the device 335 can be filled with fluid by filling through the outlet 24 by filling all or part of the reservoir 13 and all or part of the pocket 2 before inserting the valve 5 in the cavity 8. This allows to improve the priming of the device 335. In this case the valves 4 and 5 are illustrated in FIG. 50b, and the device is without groove/channel 18 on the cavity 8. In this case the piece forming the valves 4, 5 has a hump 337 or a clip 337 which is put in the of admission hole(s) 124.

The plug 351 plugs the interface between the outside of the device according to the invention and the pocket 2.

The plug 352 plugs the interface between the pocket 2 and the reservoir 13.

The plug 351 is formed at least in part by the valve 5.

The plug 352 is formed at least in part by the valve 4.

The seal 318 is easily removable and can be preferably fitted into the part 312, 315, in particular to be cleaned. Preferably the seal 318 is removable, can be maintained when the applicator is interlocked in the head 315 or in the applicator 317.

In a variant not shown, the part 23 may be in two parts separating the valves 4 and 5, these two parts being connected by a sealed connector which can be in the piece 89. These two parts may be fitted together in a non-removable manner. Preferably the spout which contains the dispensing valve 5 is in one part. The filling may be done before the connection of the dispensing valve.

This dispensing part 23 may be arranged to be mounted in a hood or cap for protection. Thus it can be connected after filling at the same time as the installation of the hood or cap for protection. The connection may be arranged to be no longer removable at the end of the connection operation after filling/closing the protective hood-cap. This is true also in the case of the valve. The spout may be replaced by a head. The dispensing part 23 plugs/closes the pocket 2.

The wall 22 is in a bag 14.

Note in FIG. 49 that the product (fluid) to be dispensed goes back and forth in the same inlet and outlet port of the pocket 2 to enter and exit the pocket.

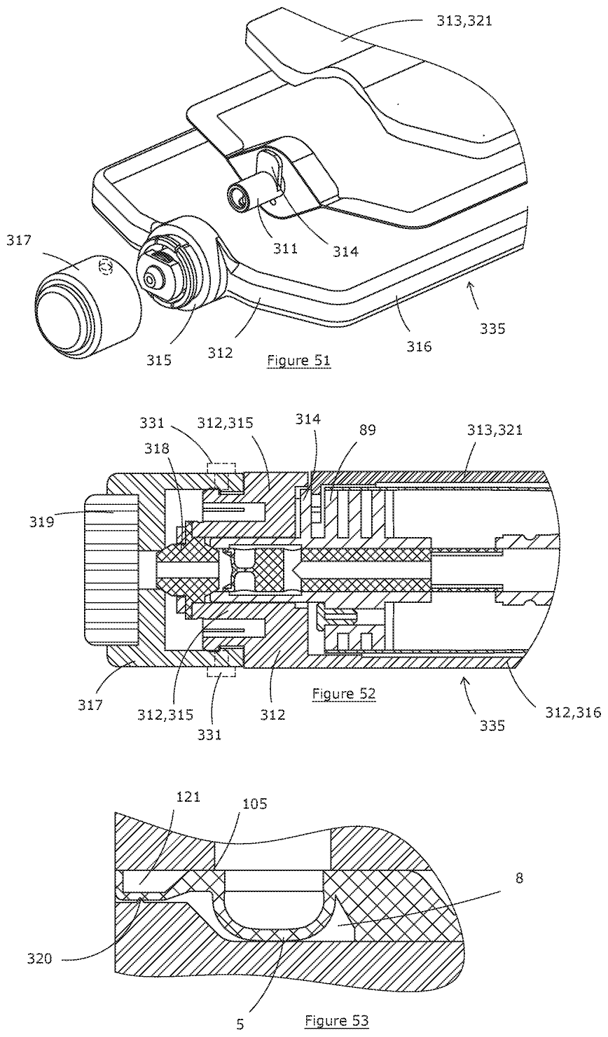

We will now describe, with reference to FIG. 53, a variant of cavity 8 which can replace the cavity 8 of each of FIGS. 1 to 40 and 44 to 47 and 57 to 58, solely for its differences with respect to the embodiment of the FIG. 28.

In this variant, the cavity 8 comprises an angular point 320 in contact with the wall of the cavity 121, arranged to create a lateral compression zone of the cavity 121. This improves the sealing of the valve 5.

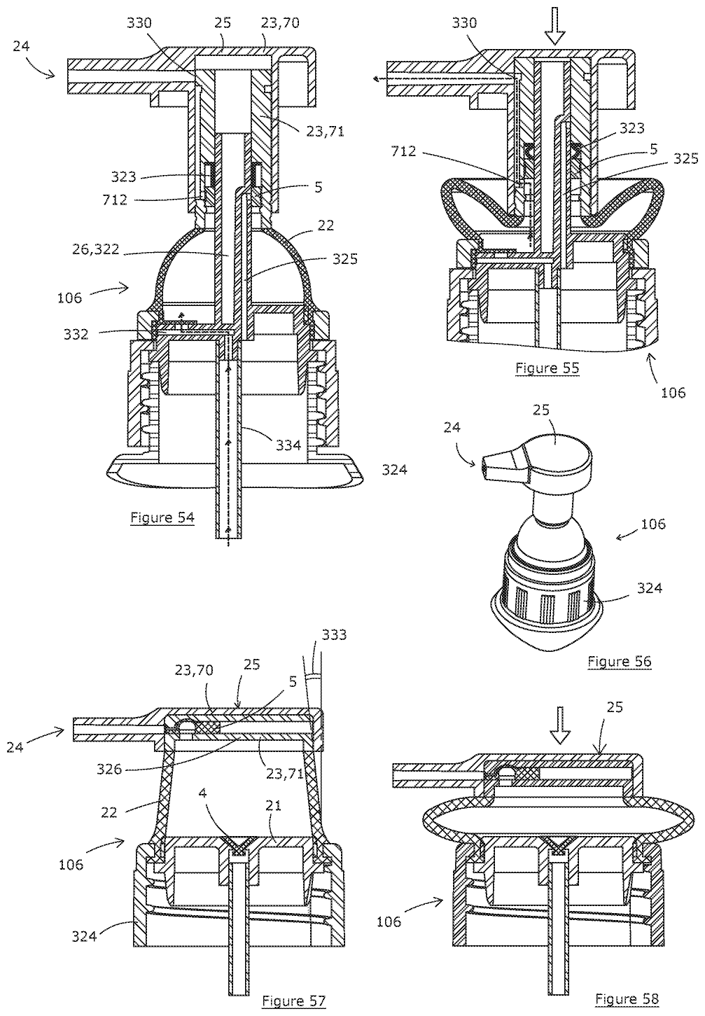

A sixth embodiment of the device 106 according to the invention will now be described, with reference to FIGS. 54 to 56, solely for its differences with respect to the embodiment of FIG. 33.

In this embodiment, the pressing surface 25 is arranged so that a press (illustrated in FIG. 55) on the surface 25 deforms the wall 22 by crushing the wall 22.

A rigid element 322 (typically a tube) connects the bottom wall 21 and the dispensing part 23 and is arranged to guide the translation of the part 23 relative to the bottom wall 21.

The element 322 is integral with the wall 21. The element 322 and the wall 21 are within one and the same piece without discontinuity of material.

The element 322 enters the part 23 and is arranged to slide in the part 23 (more exactly in the insert 71).

A spring or return means 323 (optional) is arranged to return the valve 5 from its open position to its closed position. The return means 323 comprises a deformable ring surrounding the element 322, is compressed between the part 23 (more exactly the insert 71) and the valve 5 when the valve 5 is in its open position.

The valve 5 comprises a movable element, preferably a rigid or semi-rigid ring, surrounding the element 322. In the closed position of the valve 5 (FIG. 54), the valve 5 plugs a channel connecting the pocket 2 to the outlet 24. In the open position of the valve 5 (FIG. 55), the valve 5 is moved so as not to plug this channel connecting the pocket 2 to the outlet 24; more exactly, it is moved:
sliding in the part 23 (more exactly in the insert 71) while approaching the exit 24
sliding around the element 322 while approaching the bottom wall 21.

What moves the valve 5 is the relative friction between on the one hand the valve 5 and the part 23 (more exactly the insert 71) and on the other hand between the valve 5 and the element 322. Preferably the friction is more important on the element 322 so as to have an easier movement of the valve 5 in the insert 71 to open the orifice 712 in the insert 71 (the overpressure also contributes to the displacement of the valve 5). The orifice 712 is lateral with respect to the element 322. When pressing on the pressing surface 25, the liquid of the pocket 2 circulates between the element 322 and the insert 71 and then passes laterally into the orifice 712 away from the center of the device or the element 322 and follows a path substantially parallel to the axis 322 (to the outside of 322).

An fixing ring 324 surrounding the wall 21 holds the bottom wall 21 to the reservoir 13 by clamping.

A duct 325 connecting the inside of the reservoir 13 to the outside of the device 106 without passing through the pocket 2 makes it possible to balance the pressures between the inside of the reservoir 13 and the outside of the device 106 when the valve 5 is in open position, this duct 325 being open (FIG. 55) when the valve 5 is in its open position. This duct 325 is closed (FIG. 54) when the valve 5 is in its closed position, this duct 325 (more exactly the hole 712) being then obstructed by the valve 5.

The wall 22 is visible by a user from outside the device 106.

The device 106 works even if a little pressing on the head, in this case the valve 5 can be opened.

The device 106 comprises a locking device, which locks:
a relative position of the cap 70 and the insert 71 so that the insert 71 closes the channel 330 connecting the valve 5 to the outlet 24 at an interface between the cap 70 and the insert 71 (pulled up position of the cap or head), and
a relative position of the cap 70 and the insert 71, different in the case where the valve 5 is closed, so that the insert 71 no longer closes the channel 330 connecting the valve 5 to the outlet 24 at an interface between the cap 70 and the insert 71 (pushed down position of the head or cap).

The valve 5 is arranged to remain open (with a minimum opening of 1 mm² for at least 0.5 seconds) without necessarily requiring overpressure greater than 0.2 or 0.5 bar in the pocket 2 relative to the outlet 24.

The wall 22 and/or the insert 71 and/or the ring 324 may be manufactured in the same piece, for example with overmolding, and therefore be integral. The ring 324 may be screwed or clipped.

The feed tube 334 is preferably located around the center, a channel 332 connects the tube 334 with valve 4, in the bottom wall 21. This channel 332 is plugged laterally by a portion of the pocket 2 and/or the ring 324.

In contrast to FIG. 33 for which the guide 26 was external to the part 23 or the insert 71, in the case of FIG. 54 the guide means 26 are internal to the part 23 or the insert 71, and are preferably formed by the element 322 sliding in the insert 71.

The channel 332 in the bottom wall 21 is arranged to center relative to the reservoir 13 to within plus or minus 5 mm the position of the tube 334 immersed in the reservoir 13 and connecting the reservoir 13 to the pocket 2, despite the existence of the tube 322 also centered.

It is therefore noted that this device embodiment according to the invention comprises the rigid element 322 connecting the bottom wall 21 and the dispensing part 23 and arranged to guide a translation of the dispensing part 23 relative to the bottom wall 21, the dispensing valve 5 being arranged to slide by friction around the rigid element 322 so that in the open position of the dispensing valve 5 the dispensing valve releases a passage of the fluid to be dispensed along a lateral channel (more exactly the opening 712 of this lateral channel) located in the dispensing part 23 and connecting the pocket 2 to the outlet 24.

A variant of the sixth embodiment of the device 106 according to the invention will now be described, with reference to FIGS. 57 to 58, solely for its differences with respect to the embodiment of FIGS. 54 to 56.

The cavity is only in the insert 71.

In this variant, the insert 71 comprises the cavity 8 which comprises an outlet:
opening on the outside of the insert 71 without going through the pocket 2
opening into the air before assembly of the insert 71 and the cap 70
closed by the cap 70 after assembly of the insert 71 and the cap 70.

This allows to easily insert the valve 5 in the cavity 8 by this outlet.

The interior volume of the pocket 2 is delimited:
on the top by a wall 326 of the part 23 (more exactly of the insert 71) which also delimits the cavity 8
on the bottom by the bottom wall 21
on the sides by the deformable flexible wall 22.

The wall 22 and the wall 326 are portion of the part 23, more exactly of the insert 71. The wall 22 is integral with the wall 326 and is typically obtained by overmolding on the wall 326.

This wall 22 is arranged to bend during a pressing on the surface 25, as illustrated in FIG. 58.

The valve 4 comprises a flexible wall placed on the bottom wall 21.

The wall 22 and/or the cap 70 and/or the insert 71 and/or the ring 324 can be manufactured in the same piece, for example with overmolding, and therefore be integral. In the case where the wall 22 and the cap 70 and the insert 71 and the ring 324 are manufactured in the same piece, the outlet 24 is enlarged with respect to FIG. 57 to allow the insertion of the valve 5 into the cavity 8 through the outlet 24.

The pocket 2 has a truncated cone shape whose apex angle 333 is less than 20°, preferably less than 10° even 5°.

The dispensing part 23 is located at the top of the pocket 2 which has a truncated cone shape.

A seventh embodiment of the device 700 according to the invention will now be described, with reference to FIGS. 59 to 64, solely for its differences with respect to the embodiment of FIG. 40.

In this embodiment, the cartridge or module 800 no longer comprises a valve 5.

The valve 5 is in the cavity 8 located in a head formed by the dispensing part 23.

More exactly, the cavity 8 is in a tube 701 (as shown in FIG. 59) or a module 701 (as illustrated in FIG. 62).

The tube 701 or valve module 701 is integrated in the part 23.

The dispensing part 23 has a spout shape and the cavity 8 is located in the part 701 that is removable with respect to the dispensing part 23.

The part 23 comprises connecting means 702 which may comprise piercing means 708 arranged to pierce the wall 22 at the time of the insertion of the means 702 into the device 700.

The means 702 comprise:
either an end of the tube 701 opposite the end of the tube 701 containing the valve 5: in this case, these means 702 (708) are arranged to connect to the wall 22 by piercing it, when the part 23 is already in placed in the device 700 and the tube 701 is inserted into the part 23, and/or when the part 23, already comprising its tube 701, is inserted in the device 700
or a portion integral with the part 23: in this case, these means 702 (708) are arranged to connect to the wall 22 and pierce it, when the part 23 is inserted in the device 700.

A preferably central area of the wall 22 comprises connection means 703, 704, 710 arranged to connect to the means 702:
in the case illustrated in FIGS. 59 to 64, the connection means 702 of the part 23 comprises means 708 for piercing the connection means 703, 704, 710 of the wall 22. These means 703, 704, 710 are arranged to be pierced by the means 702 and may comprise a cover 710 of different material or with continuity of material relative to the rest of the wall 22. The means 703, 704, 710 form a connector with the inside of the pocket 2.
In a non-illustrated inverse variant, the connection means 703, 704, 710 of the wall 22 comprise means 708 for piercing the connecting means 702 of the part 23.

A seal 703 is arranged to seal the junction (sealed connector) between an outer periphery of the means 702 and the wall 22. This seal 703 either is disposed on the outer periphery of the means 708 (FIG. 64) or is integral with the wall 22. (FIG. 61).

The wall 22 forms a connector 703, 704, 710 carried by the wall 22 and located:
in the case of FIGS. 59 to 64, inside the pocket 2 and arranged to form a receiving cavity 704, means 702. This cavity or recess 704 is located between the cover 710 or pierced area of the wall 22 and the seal 703.
in the opposite variant not shown, outside the pocket 2 and arranged to form a pin 704 connection with the means 702.

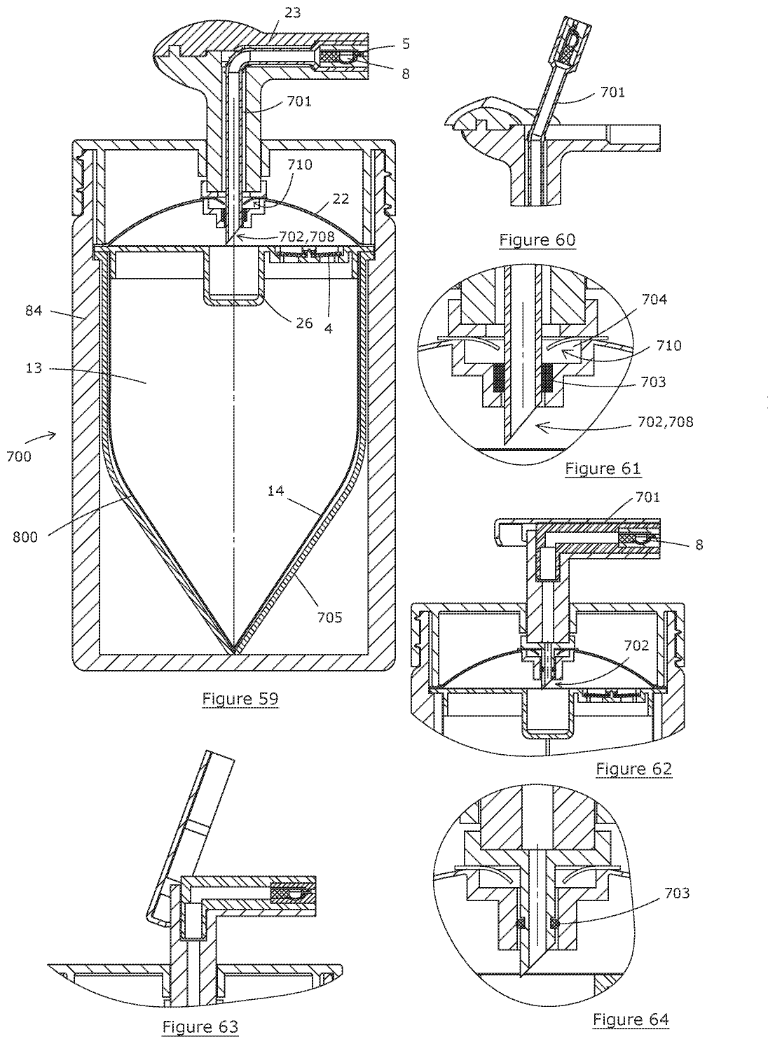

In the case of the variant of FIGS. 60 and 61, the part 23 is in two parts that can pivot relative to each other to allow the insertion of the tube 701 from above while this tube is straight or substantially rectilinear, before folding this tube 701 to then be able to close the two parts of the part 23.

In FIGS. 62 to 64 the two parts of the part 23 are arranged to pivot vertically while in FIGS. 59 to 61 they rotate horizontally. The tube or valve module 701 is removable from the part 23 and held in a locked position of the two parts of the part 23.

In an alternative, the means 702 is arranged not to pierce the wall 22 but to be inserted or connected directly into a hole formed in the wall 22. This hole may be made for example by a removed cap.

The device 700 comprises a sheath 705 (in the case 84) arranged to press the reservoir so as to raise fluid from the reservoir to the pocket 2 during insertion of the cartridge 800 into the case 84.

This device 700 is a bottle, the part 23 forming a head located at the top.

A priming method of this device 700 comprises a rise of fluid from the reservoir 13 to the pocket 2 while the pocket 2 communicates with the air outside device 700, whether by the pre-piercing of the wall 22 (by example by manual removal or other of the lid) or by piercing the wall 22 by the means 702 but before the means 702 reaches the seal 703. This rise is caused by the pressing of the sheath 705 over the cartridge 800, the sheath that may be part of the case. This rise brings the product at least to the seat of the intake valve 4.

The bottom wall 21 comprises a recess arranged to receive at least a portion of the dispensing part 23, more exactly the connector 702, after the dispensing part has moved towards the bottom wall 21. This recess is also the guiding means 26.

The connector 702 is preferably sterile.

Therefore, there is a cartridge 800 or non-removable module (see FIG. 49) for the device 700, this cartridge comprising:
the bottom wall 21
the feed valve 4
the pocket 2 equipped with the connector 704, 703 (intended to be connected to the dispensing valve 5), this connector comprising the elements 704 and 703 and at least one part that can be pierced or openable, this pocket 2 comprising the deformable wall 22
the reservoir 13 preferably flexible, formed by the film 14 and/or by a skirt formed by the bottom wall 21 or the deformable wall 24. This reservoir 13 is completely or partially filled (preferably at least at the seat of the intake valve, preferably at least 10% of its interior volume or even at least 30% (this depends on the viscosity of the fluid) of its interior volume) with the product (fluid) to be dispensed.
the reservoir 13 can be welded by ultrasound at the wall 21 and/or the wall 22.

Of course, the invention is not limited to the examples that have just been described and many adjustments may be made to these examples without departing from the scope of the invention.

Note that, in all embodiments, the wall 22 serves as a spring.

Note that all of the embodiments may be primed even head up.

For example, in a variant of the device 102 or 103, the valve 4 can be replaced by a valve 4 of the “tongue” type as in FIGS. 1 to 11. In this case the channel 30 (and the member 31) disappears and the air cavity 38 occupies practically all the part 23.

In a variant of the device 103 of FIGS. 18 to 21, the rod 36 is arranged to close not the valve 4 but the valve 5 or the dispensing orifice 108. For this, the rod 36 passes through bottom wall 21. The valve 4 is located at a location laterally offset from the views of FIGS. 18 to 21.

The wall 22 may have a shape of dome 22 and the wall 21 may also have a dome shape (so as to form a bubble).

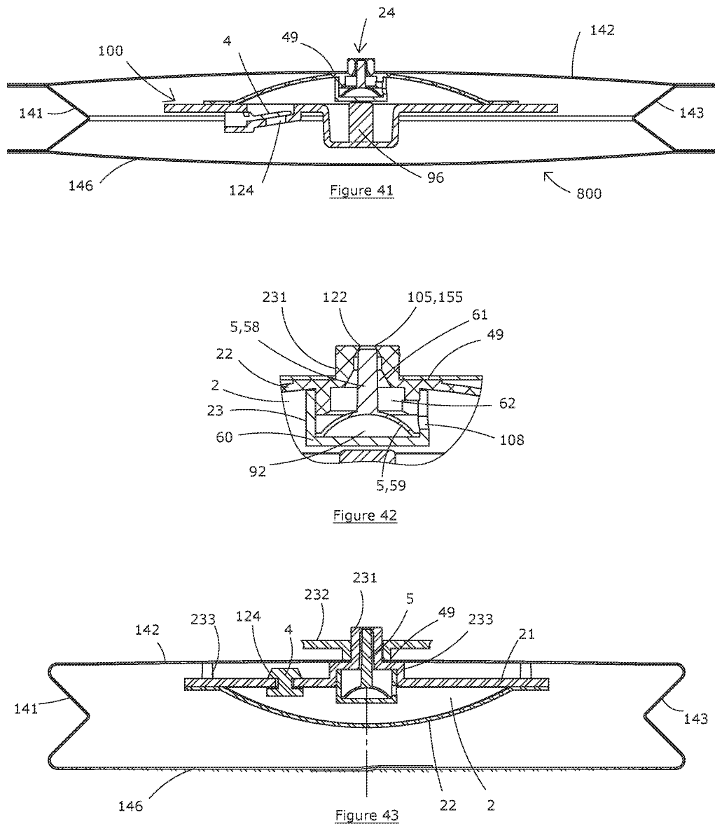

In addition, for each of the variants and for each of the embodiments described above:
in the case (not shown) where the feed duct 6 and the reservoir 13 are not confluent, they are connected by a fluid path passing through neither the pocket 2 nor the orifice 124; and or
the device according to the invention may comprise more than one outlet 24; and or
the wall 22 may be of flexible material (such as a TPE) overmolded or bi-injection with the part 23 or the cap 70
as illustrated in FIGS. 38 and 39, in each of the variants and embodiments of FIGS. 1 to 40:
the pocket 2 may be filled with a sponge or an impregnation means 87 arranged to imbibe with the fluid, and/or
the reservoir 13 may be filled with a sponge or an impregnation means 87 arranged to imbibe with the fluid
   this allows a better preservation of the fluid if the latter comprises an emulsion or a mixture of phases or components whose mixture is unstable and/or has a tendency to separate.

With reference to FIGS. 41 to 43, for all the embodiments:
the dispensing valve 5 can be replaced by a rod 58 (or a stud) having an end or end piece 122 which closes the outlet 24 on an annular seat 155, the rod 58 being connected in the pocket 2 to a movable wall 59 of at least one gas pocket 92. It is noted that the seat 155 is coincident with the seat 105. The closure of the dispensing valve is located in the connecting stud 231, more precisely the seat 155 of the dispensing valve 5 is located in the connecting stud. The rod 58 is partly in the smaller cavity 61. The movable wall 59 is placed in the largest cavity 62 of the dispensing cavity 8 and is held by a cup 60 fixed on the deformable wall 22. The dispensing part 23 comprises the cup 60 and the stud 231. The connection means 47,48 comprise the stud 231 and a part of the movable dispensing wall 83; and/or
The bag 14 advantageously may be welded around the outlet 24 more precisely around the connecting stud 231 on a ring 49 of the deformable pocket 22. In order to maintain the deformable pocket 22 during the welding efforts of the bag 14, a blocking element 96 makes it possible to limit the displacement of the part 23 and thus to limit the displacement of the deformable wall 22. This blocking element 96 is a breakable tongue located on the bottom wall 21 or the part 23, it is broken after welding the bag 14 on the ring 49 to release the displacement of the deformable wall 22; and/or
The bag 14 advantageously has two lateral bellows 141, 143 bordering two large front face 142 and rear face 146 of the bag 14. The dispenser 100 comprises the bottom wall 21, the valves 4, 5, the dispensing part 23 and the deformable pocket 2 and may be, for example during a continuous line manufacturing, be welded inside the bag 14 before complete closure of the bag 14. The welding of the dispenser 100 is performed on the large front face 142. The bag 14 can be realized:
by the assembly of two welded films respectively forming the two large faces 142, 146 as shown in FIG. 41. In order to arrange the dispenser 100 easily without obstruction, the distributor 100 is welded on the large face 142, before the opposite large face 146 is welded to the bellows 141 or 143; or
by closing a single film as illustrated in FIG. 43, typically by welding along the large rear face 146. In order to arrange the dispenser 100 easily without obstruction, the dispenser 100 is welded to the large front face 142, before the opposite large rear face 146 is closed or welded.

Of course, the various features, shapes, variants and embodiments of the invention can be associated with each other in various combinations.

In addition, in each embodiment or variant previously described:
the dispensing part 23 may comprise a connection element, preferably a connection stud 231 for connecting to the dispensing ring 28 or movable dispensing wall 83. The closure of the dispensing valve 5 may be at (or in) the dispensing stud 213 (PI valve rod closes at the end); with reference to FIG. 43, the connecting stud 231 may be emerging so as to form a spout emerging from the device according to the invention for a user, for example emerging from an outer contour or case 232 of the device according to the invention; and/or
with reference to FIG. 43, the device according to the invention may comprise means 233 arranged to separate the pocket 24 from the feed orifice 124; and or
with reference to FIG. 43, the bottom wall 21 may be closer to the bag 14 (more exactly to the face 142 of the bag 14) than to the wall 22; and/or
with reference to FIG. 43, the dispensing part 23 is integral with the bottom wall 21 (and not the wall 22); and or
with reference to FIG. 43, the wall 22 has its concave face facing the inside of the pocket 2; and/or
with reference to FIG. 43, a displacement of the wall 22 (for example by a user pressing the wall 22 and/or 146 to dispense fluid) does not cause displacement of the part 23 or the cavity 8, the part 23 and the cavity 8 remaining fixed relative to the bottom wall 21; and/or
the device according to the invention may comprise a removable refill 800 arranged to be placed in a case 84 and connected to the dispensing ring 28 (or the movable dispensing wall 83). As illustrated in FIG. 41, the walls of the reservoir 13 may comprise a bag 14 that may be welded (around the outlet 24) to the top of the deformable wall 22, preferably around the connecting stud 231 on a large face 142 of the bag 14. The cartridge 800 may be held in the case 84 by the bottom wall 21 or the edge 211.

1-39. (canceled)

40. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity,
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity,
the interior volume of the pocket is delimited at least in part by the deformable wall and a bottom wall, and
the device comprises a feed orifice connecting the reservoir to the interior volume of the pocket,
wherein:
the dispensing part is placed or nestled to the bottom wall, and
the dispensing part carries the dispensing orifice and is assembled with the bottom wall on the side of its dispensing orifice.

41. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity,
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity, and
the interior volume of the pocket is delimited at least in part by the deformable wall and a bottom wall,
wherein the cavity has an oblique inclination direction forming an angle of at least 3° with respect to at least one laying plane of the deformable wall on the part forming the bottom wall.

42. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity, and
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity,
wherein:
the device comprises a plurality of outlets and a plurality of dispensing orifices, and
the dispensing part comprises a plurality of dispensing assemblies, each dispensing assembly comprising a dispensing cavity in which is located a dispensing valve which, in an open state, allows a fluid passage from the interior of the pocket to one of its associated outlets via one of the dispensing orifices associated with it and its dispensing cavity, and in a closed state, does not allow a fluid passage from the interior of the pocket to its associated outlet via the dispensing orifice associated with it and its dispensing cavity.

43. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity,
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity,
a reservoir,
a feed orifice connecting the reservoir to the interior volume of the pocket, and the interior volume of the reservoir comprising a sponge or a means for impregnating the product to be dispensed.

44. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity,
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity, and
further comprising a rigid element connecting the bottom wall and the dispensing part and arranged to guide a translation of the dispensing part relative to the bottom wall, the dispensing valve being arranged to slide by friction around the rigid element so that, in the open position of the dispensing valve, the dispensing valve releases a passage of the fluid to be dispensed along a lateral channel located in the dispensing part and connecting the pocket to the outlet.

45. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity, and
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity,
wherein the dispensing part forms a spout in which the cavity is located, the dispensing part and the reservoir are mounted within a case formed by two parts, one of these parts comprises a head, the spout is mounted by insertion into the head from the inside of the case.

46. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity,
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity, and
a pressing surface is arranged to, under the effect of pressure, reduce the interior volume of the pocket by deforming and/or moving the deformable wall while moving the dispensing cavity and the dispensing valve in the direction of the bottom wall, wherein the part comprises connecting means with the wall.

47. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity, and
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity,
wherein the cavity comprises a small opening and a large opening, the passage between the large opening and the small opening being made by a filling element of the cavity.

48. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity, and
a dispensing valve located in the dispensing cavity, and which in an open state, allows a fluid passage from the interior of the pocket to the outlet via the dispensing orifice and the dispensing cavity, and, in a closed state, does not allow a fluid passage from the interior of the pocket to the outlet via the dispensing orifice and the dispensing cavity,
wherein
the dispensing part comprises a cap,
the cap is provided with the pressing surface, and
the deformable wall is arranged not to be movable in the cap.

49. The device according to claim 40, wherein the cap is mounted superimposed on the deformable wall.

50. The device of claim 40, wherein the deformable wall and the cap are grouped in a single piece of the same material without discontinuity of material.

51. The device according to claim 40, wherein the dispensing head is of monoblock.

52. The device according to claim 40, wherein the deformable wall is closed by a wall which:
has a substantially planar border, and
carries the cap placed outside the pocket.

53. The device according to claim 40, wherein the bottom wall faces the deformable wall and the deformable wall has a concave shape oriented towards the bottom wall, wherein the interior volume of the pocket is delimited at least in part by the deformable wall and by a bottom wall.

54. The device according to claim 40, wherein the dispensing valve comprises a rod or a stud which has an end or end piece which closes the outlet on an annular seat.

55. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity, and
a dispensing valve located in the dispensing cavity, and which in an open state, allows a fluid passage from the interior of the pocket to the outlet via the dispensing orifice and the dispensing cavity, and, in a closed state, does not allow a fluid passage from the interior of the pocket to the outlet via the dispensing orifice and the dispensing cavity,
wherein
the dispensing part comprises a cap,
the cap is provided with the pressing surface,
the deformable wall is arranged not to be movable in the cap, and
the dispensing valve is placed in a sliding cavity of the cap, the dispensing valve being arranged to be moved to the outlet by sliding in this sliding cavity.

56. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity,
a dispensing valve located in the dispensing cavity, and which in an open state, allows a fluid passage from the interior of the pocket to the outlet via the dispensing orifice and the dispensing cavity, and, in a closed state, does not allow a fluid passage from the interior of the pocket to the outlet via the dispensing orifice and the dispensing cavity,
wherein
the pressing surface comprises the deformable wall,
the outlet is located on the dispensing part,
the pressing surface does not surround the outlet,
the interior volume of the pocket is delimited at least in part by the deformable wall and by a bottom wall,
the device comprising a cover comprising the deformable wall and the outlet, and
the pocket extends between the cover and the bottom wall.

57. The device according to claim 40, wherein the dispensing part comprises a dispensing surface near the outlet.

58. The device according to claim 40, wherein a direction of dispensing of the fluid through the outlet is opposite to a direction of pressing on the pressing surface.

59. The device according to claim 40, wherein the deformable wall and the dispensing part or at least a part of the dispensing part form a single piece without discontinuity of material.

60. A device for dispensing a fluid, comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity, and
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity,
wherein:
the interior volume of the pocket is delimited at least in part by the deformable wall and by a bottom wall,
the device comprises a reservoir delimited by the reservoir walls and the bottom wall,
the bottom wall being arranged so that only two exits allow access to the interior of the reservoir: a feed orifice and a filling hole, and
at least one of the reservoir walls and the bottom wall being joined to the deformable wall in one piece.

61. A method for manufacturing a fluid dispensing device comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity,
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity, and
comprising a step of filling at least a portion of the pocket while it is open in communication with the outside of the device without passing through the dispensing valve, either in a same step of filling as a reservoir, or before or after the step of filling the reservoir.

62. A method for priming a device comprising:
a pocket having an interior volume arranged to contain the fluid, the interior volume being delimited at least in part by a deformable wall,
a pressing surface arranged to, under the effect of pressure, reduce the interior volume of the pocket by deforming the deformable wall,
a dispensing part comprising a dispensing cavity,
an outlet,
a dispensing orifice connecting the pocket to the dispensing cavity, and
a dispensing valve located in the dispensing cavity, and in an open state, allows a fluid passage from the interior of the pocket to the outlet via the dispensing orifice and the dispensing cavity, and in a closed state, does not allow a fluid passage from the interior of the pocket to the outlet via the dispensing orifice and the dispensing cavity,
wherein the fluid to be dispensed contained in a reservoir is subjected to an overpressure without the dispensing valve blocking the flow of gas or of fluid to be dispensed.
